(19) United States
(12) Patent Application Publication
(10) Pub. No.: US 2010/0085602 A1
(43) Pub. Date: Apr. 8, 2010

(54) IMAGE FORMING APPARATUS AND PREVIEW DISPLAY METHOD

(75) Inventor: Mikiya Okada, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/573,439

(22) Filed: Oct. 5, 2009

(30) Foreign Application Priority Data
Oct. 6, 2008 (JP) 2008-259571

(51) Int. Cl. G06K 15/00; G06F 17/00

(52) U.S. Cl. 358/1.18; 715/274

(57) ABSTRACT

An image forming apparatus is provided with an image display portion such as a touch panel for displaying a preview of image data. When image data of the object to output is output with additional information added thereto or when the image data of the object to output is printed on recording paper and post processing is applied to the recording paper, the image forming apparatus combines an additional information image showing additional information or post processing with a preview image at a position corresponding to an adding position of additional information or a position at which post processing is applied in displaying the preview image by enlarging a part where the additional information image is combined to display on the touch panel.

### CROSS-NOTING PARAGRAPH

This non-provisional application claims priority under 35 U.S.C. §119(a) on Patent Application No. 2008-259571 filed in JAPAN on Oct. 6, 2008, the entire contents of which are hereby incorporated herein by reference.

### FIELD OF THE INVENTION

The present invention relates to an image forming apparatus capable of displaying a preview of image data before outputting, a preview display method in the image forming apparatus, and a preview display method in a computer connected to the image forming apparatus.

### BACKGROUND OF THE INVENTION

Conventionally, some image forming apparatuses such as multi-functional peripherals have a function of displaying a preview of image data that is the object of the output to be printed or sent.

For example, Japanese Laid-Open Patent Publication No. 2005-73015 discloses an image processing apparatus in which it is determined whether image data that is the object of a preview display is a text image or a gradation image, and in the case of the text image, a preview magnification that enables to recognize text is set to perform the preview display at the preview magnification.

However, even when a final state of image formation is confirmed by a preview display, in the case of outputting an image data that is the object of the image formation with additional information added thereto, or in the case of outputting a recording medium where post processing such as punching or stapling is applied, a point considered to be important at the time if the confirmation is generally changed depending on the addition of additional information or the post processing.

For example, confirmation points in copying include whether there is no problem in the visibility of the entire image, or in a position relationship between staple or punch holes and the image (whether the image and the punch are not overlapped) and whether additional information such as a stamp image of “TOP SECRET”, “CIRCULAR”, “URGENT”, or the like, that is set to be added by a user on his/her own, a page number, and date information are surely added.

To confirm these conformation points by a user, a user operation to enlarge, reduce, or shift image data displayed for previewing is required.

In addition, although the art described in Japanese Laid-Open Patent Publication No. 2005-73015 is to differentiate conditions in a preview after determining characteristics of an image, it is not able to change a display form of a preview image automatically in accordance with an addition of additional information or post processing but to differentiate a display form according to characteristics of the image. Accordingly, even when the art described in Japanese Laid-Open Patent Publication No. 2005-73015 is employed, to confirm the above confirmation points by a preview display, the user operation such as enlarging, reducing, or shifting is required.

### SUMMARY OF THE INVENTION

An object of the present invention is, in view of the actual circumstances above, to provide an image forming apparatus capable of confirming additional information to be added or post processing to be applied in displaying a preview without requiring a user operation such as enlarging, reducing, or shifting when outputting image data that is the object of the output with additional information added thereto, or outputting a recording medium to which post processing such as punching or stapling is applied, a preview display method in the image forming apparatus, and a preview display method in a computer connected to the image forming apparatus.

Another object of the present invention is to provide an image forming apparatus which has an image display portion for displaying a preview image of image data of an object to output, wherein a display control portion is included, when outputting the image data of the object to output with an additional information added thereto, or printing the image data of the object to output on recording paper and applying post processing to the recording paper, to superimpose an additional information image showing the additional information or the post processing on the preview image at a position corresponding to an adding position of the additional information or a position at which the post processing is applied in displaying the preview image and to enlarge and display a part where the additional information image is superimposed.

Another object of the present invention is to provide the image forming apparatus, wherein an display control portion displays an information showing a position relationship between the entire page of the preview image and the additional information image together with the preview image on which the additional information image is superimposed on the image display portion.

Another object of the present invention is to provide the image forming apparatus, wherein the display control portion displays a part on which the additional information image is superimposed one after another according to a predetermined priority order when there are a plurality of additional information images to be superimposed on the preview image.

Another object of the present invention is to provide the image forming apparatus, wherein the predetermined priority order is an order that the additional information image superimposed on the upper part of the preview image is given preference over the additional information image superimposed on the lower part thereof.

Another object of the present invention is to provide the image forming apparatus, wherein when adding a stamp image as the additional information, the predetermined priority order is an order that the additional information image showing the stamp image is given preference over the other additional information image.

Another object of the present invention is to provide the image forming apparatus, wherein a switch operation portion is further provided to receive a user operation for performing switching of a display of the additional information image, and the display control portion executes the switching according to the predetermined priority order based on the user operation received by the switch operation portion.

Another object of the present invention is to provide a preview display method in an image forming apparatus provided with an image display portion that displays a preview image of image data of an object to output, wherein a step in which the image forming apparatus, when the image forming apparatus outputs the image data of the object to output with an additional information added thereto, or when the image forming apparatus performs post processing to recording paper after printing the image data of the object to output on the recording paper, superimposes an additional information image showing the additional information or the post processing on the preview image at a position corresponding to an adding position of the additional information or a position at which the post processing is applied in displaying the preview image; and a step in which the image forming apparatus enlarges a part on which the additional information image is superimposed, and displays the preview image.

Another object of the present invention is to provide a preview display method, comprising: a step in which a computer generates a preview image from an image data of an object to output by an image forming apparatus connected to the computer; a step in which the computer, when it outputs the image data of the object to output with an additional information added thereto in the image forming apparatus, or it applies post processing to recording paper after printing the image data of the object to output on the recording paper, superimposes an additional information image showing the additional information or the post processing on the preview image at a position corresponding to an adding position of the additional information or a position at which the post processing is applied at the time of displaying the preview image; and a step in which the computer enlarges a part on which the additional information image is superimposed and displays the preview image on a display portion included in the computer.

### BRIEF DESCRIPTION OF THE DRAWINGS

FIG. 1 is a schematic diagram for showing an exemplary configuration of an image processing system constructed by using a digital multi-functional peripheral as an example of an image forming apparatus according to an embodiment of the present invention;

FIG. 2 is a schematic block diagram for showing an exemplary configuration of the digital multi-functional peripheral of FIG. 1;

FIG. 3 is an external view for showing an example of a touch panel and a key operation portion in the digital multi-functional peripheral of FIG. 2;

FIG. 4 is a diagram for showing an example of a standard screen of the digital multi-functional peripheral explained in FIGS. 2 and 3;

FIG. 5 is a diagram for showing an example of a GUI image displayed when selecting a special function key to perform a detailed setting in copying in the GUI image of FIG. 4;

FIG. 6 is a diagram for showing an example of a GUI image displayed when selecting an arrow key in the GUI image of FIG. 5;

FIG. 7 is a diagram for showing an example of a GUI image displayed when selecting a print menu key in the GUI image of FIG. 6;

FIG. 8 is a diagram for showing an example of a GUI image displayed when selecting an arrow key in the GUI image of FIG. 7;

FIG. 9 is a diagram for showing another example of a GUI image displayed when selecting a print menu key in the GUI image of FIG. 6;

FIG. 10 is a diagram for showing an example of a GUI image displayed when selecting a date key in the GUI image of FIG. 7 or 9;

FIG. 11 is a diagram for showing an example of a GUI image displayed when selecting a print color key in the GUI image of FIG. 10;

FIG. 12 is a diagram for showing an example of a GUI image displayed when selecting a date change key in the GUI image of FIG. 10;

FIG. 13 is a diagram for showing an example of a GUI image displayed when selecting a stamp key in the GUI image of FIG. 7 or 9;

FIG. 14 is a diagram for showing an example of a GUI image displayed when selecting a print color key in the GUI image of FIG. 13;

FIG. 15 is a diagram for showing an example of a GUI image displayed when selecting a number of page key in the GUI image of FIG. 7 or 9;

FIG. 16 is a diagram for showing an example of a GUI image displayed when selecting a page number key in the GUI image of FIG. 15;

FIG. 17 is a diagram for showing an example of a GUI image displayed when selecting a text key in the GUI image of FIG. 7 or 9;

FIG. 18 is a diagram for showing an example of a GUI image displayed when selecting a call key of a fixed sentence key in the GUI image of FIG. 17;

FIG. 19 is a diagram for showing an example of a GUI image displayed when selecting a direct input key in the GUI image of FIG. 17;

FIG. 20 is a diagram for showing an example of a GUI image displayed when selecting a print layout key in the GUI image of FIG. 9;

FIG. 21 is a diagram for showing an example of a preview display screen of the digital multi-functional peripheral explained in FIGS. 2 and 3, which shows an example of a preview display in a copy mode;

FIG. 22 is a diagram for showing an example of a preview display screen of the digital multi-functional peripheral explained in FIGS. 2 and 3, which shows an example of a preview display in an image send mode;

FIG. 23 is a diagram for showing an example of a preview display screen of the digital multi-functional peripheral explained in FIGS. 2 and 3, which shows an example of a preview display in a document filing mode;

FIG. 24 is a diagram for showing an example of a GUI image when selecting an output display key in the preview display screen of FIG. 21;

FIG. 25 is a diagram for showing another example of a GUI image when selecting an output display key in the preview display screen of FIG. 21;

FIGS. 26A and 26B are flowcharts for explaining an example of processing when displaying a preview in printing in the digital multi-functional peripheral of FIGS. 2 and 3.

FIG. 27 is a diagram for showing an exemplary configuration of a general PC, which shows an exemplary configuration of a PC to which a printer driver of the present invention is able to be incorporated;

FIG. 28 is a diagram for showing an example of a GUI image for print setting in a printer driver according to the present invention;

FIG. 29 is a diagram for showing an example of a GUI image displayed by selecting a preview confirm key in FIG. 28; and

FIG. 30 is a diagram for showing an example of a GUI image displayed by selecting an output display key in FIG. 29.

### PREFERRED EMBODIMENTS OF THE INVENTION

Now, a preferred embodiment of the present invention will hereinafter be described with reference to the drawings. An embodiment in which an image forming apparatus according to the present invention is applied to a digital multi-functional peripheral having a print function, a copy function, and a facsimile sending and receiving function, etc., will hereinafter be described specifically with reference to the drawings showing the embodiment.

### <Apparatus Configuration>

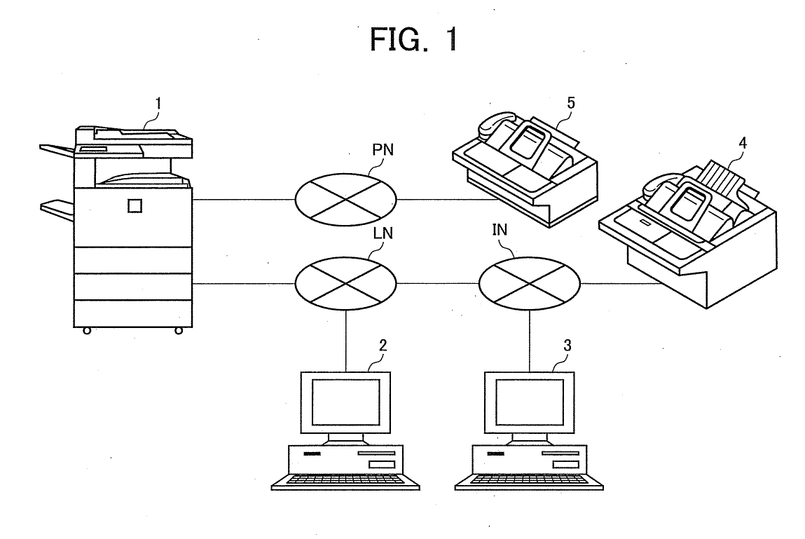

FIG. 1 is a schematic diagram for showing an exemplary configuration of an image processing system constructed by using a digital multi-functional peripheral as an example of an image forming apparatus according to an embodiment of the present invention. In FIG. 1, 1 denotes a digital multi-functional peripheral, 2 and 3 denote external computers, 4 denotes an internet facsimile apparatus (internet FAX apparatus), and 5 denotes a facsimile apparatus.

The digital multi-functional peripheral 1 has a print function and a copy function, as well as a function of sending and receiving image data by facsimile (facsimile function) and/or a function of sending and receiving image data by internet FAX (internet FAX function). This digital multi-functional peripheral 1 is connected to various external devices through a communication network. For example, an external computer 2 such as a personal computer (PC) is connected to a communication network LN that is laid as a local communication network, and an external computer 3 and an internet FAX apparatus 4 are connected to an internet network IN that is connected through a gateway not shown in the figure, or the like. Further, an external facsimile apparatus 5 is connected through a public switched telephone network PN. Note that, as described above, although description will be given only for the case where the image forming apparatus according to the present invention is applied to the digital multi-functional peripheral 1, the internet FAX apparatus 4 and the facsimile apparatus 5 are also applicable as the image forming apparatus according to the present invention.

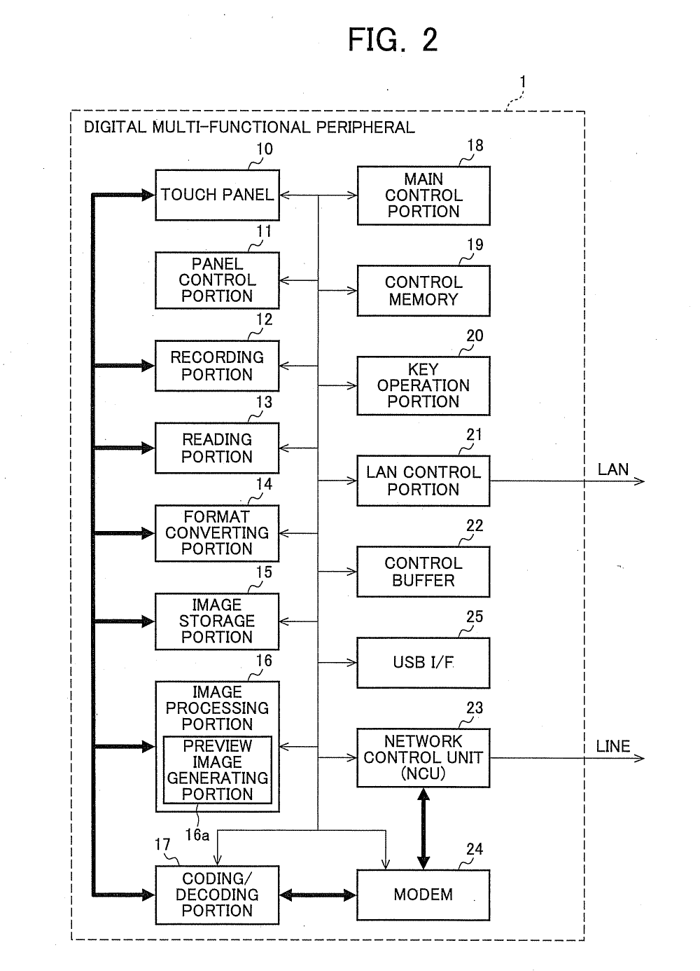

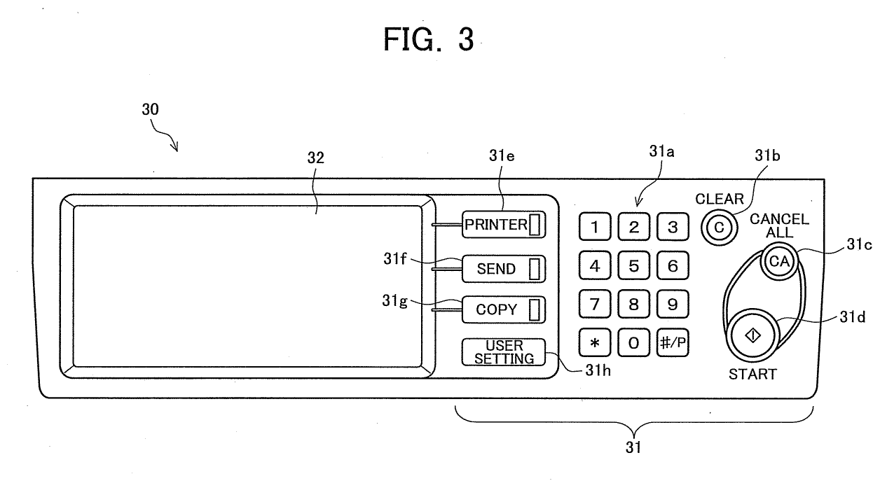

Description will be given for a configuration and an operation of the digital multi-functional peripheral 1. FIG. 2 is a schematic block diagram for showing an exemplary configuration of the digital multi-functional peripheral of FIG. 1, and FIG. 3 is an external view for showing an example of a touch panel and a key operation portion of the digital multi-functional peripheral of FIG. 2.

The digital multi-functional peripheral 1 illustrated in FIG. 2 is provided with a touch panel 10, a panel control portion 11, a recording portion 12, a reading portion 13, a format converting portion 14, an image storage portion 15, an image processing portion 16, a coding/decoding portion 17, a main control portion 18, a control memory 19, a key operation portion 20, a LAN (Local Area Network) control portion 21, a control buffer 22, a network control unit (NCU) 23, a modem 24, and a USB (Universal Serial Bus) interface (I/F) 25. In addition, the digital multi-functional peripheral 1 is preferably provided with a post processing apparatus that performs punching, stapling, and the like, and description will hereinafter be given with reference to an embodiment provided with the post processing apparatus.

The main control portion 18 is comprised of a CPU (Central Processing Unit), a DSP (Digital Signal Processor), or the like. The control memory 19 is comprised of a nonvolatile memory or the like, such as a ROM (Read Only Memory) or an EEPROM (Electrically Erasable and Programmable ROM). A program (firmware) and various setting data are stored in the control memory 19 so as to be readable from the main control portion 18. Among them, at least the various setting data is stored in a rewritable memory. The program and the various setting data may be stored in hard disc as an exemplary configuration of the image storage portion 15, which will be described below. The control buffer 22 is comprised of a volatile memory such as a RAM (Random Access Memory).

The above-described program is for the main control portion 18 to issue a command concerning generation and display of a preview image or an additional information image according to the present invention as will be described below, a command concerning generation, sending, receiving and the like of a facsimile image, an electronic mail, and the like, a command concerning original reading, a command concerning printing, a command concerning original reading and printing (that is, copying), and the like, to other parts. The program is written by the main control portion 18 on the control buffer 22 and executed with the control buffer 22 as a data region for temporary storage (work) by referring to various setting data as appropriate.

The reading portion 13 reads an original as a bitmap image of RGB (R: Red, G: Green, and B: Blue) with a predetermined resolution by a scanner using a CCD (Charge Coupled Device) and outputs the read RGB image data (dot image data) to the image processing portion 16. The image processing portion 16 is comprised of an ASIC (Application Specific Integrated Circuit) or the like, and applies various image processing to target image data. An example of the image processing will be described below. The ASIC may be incorporated with other parts such as the coding/decoding portion 17.

The image storage portion 15 is comprised of hard disc or the like, and stores image data that has been read by the reading portion 13 and has passed through the image processing portion 16, image data that has been received from outside through the LAN control portion 21, the NCU 23, etc., and the like. When image data is stored in the image storage portion 15, data that has been coded by the coding/decoding portion 17 may be also stored. Moreover, the image storage portion 15 may temporarily save intermediate data generated during image processing at the image processing portion 16.

The coding/decoding portion 17 compresses image data by coding and decodes (expands) the coded image data to original image data. For example, the coding/decoding portion 17 performs coding of image data read from an original, decoding of the coded data, decoding of coded image data received from outside, and the like. In the coding/decoding portion 17, coding systems corresponding to purposes are usable, including JPEG (Joint Photographic Experts Group) that is generally used in filing, and MH (Modified Huffman), MR (Modified READ) and MMR (Modified Modified READ) that are generally used in facsimile communication. As the coding system, MH is employable in IP facsimile communication, and JPEG and JBIG (Joint Bi-level Image Experts Group) as well as MH, MR, and MMR are employable in internet facsimile communication.

The format converting portion 14 converts read image data or image data received from outside into a predetermined file format such as a PDF (Portable Document Format), a GIF (Graphics Interchange Format), or a TIFF (Tag Image File Format).

The recording portion 12 is provided with a printer apparatus that employs a printing system such as an electrophotographic system or an inkjet system, and records (that is, prints) image data and the like stored in the image storage portion 15 on recording paper. The USB I/F 25 is an I/F for connecting to a USB device such as a USB memory, and outputs image data and the like after original reading that is stored in the image storage portion 15 to the USB device or reads a file from the USB device.

The modem 24 is comprised of a facsimile modem capable of facsimile communication, and is connected to a telephone line and is directly connected to the NCU 23. The NCU 23 is connected to the telephone line to control the line. That is, the NCU 23 is a hardware that performs an operation of closing and opening the line with an analogue public switched telephone network (PSTN), and connects the modem 24 to the public switched telephone network as the occasion demands. Such a configuration enables to send image data stored in the image storage portion 15 to outside by facsimile, to receive facsimile image data from the telephone line to store in the image storage portion 15, or to print by the recording portion 12 directly.

The LAN control portion 21 is connected to a LAN and performs communication of electronic mail data and communication of internet FAX via an internet. The internet FAX uses a LAN interface or the like to send and receive an electronic mail through a computer network such as a LAN.

The touch panel 10 or the key operation portion 20 receives an operation for selecting desired processing out of processing of reading an original, processing of sending and printing image data, etc., an operation for staring the processing, an operation for performing a setting that is necessary when each processing is executed (a selecting operation or an inputting operation), and the like. Various examples of the setting include a setting of the number of printed sheets in printing, a setting of punching and stapling and a setting of destination information in sending a facsimile image or an electronic mail.

The key operation portion 20 is provided with a key group necessary for operations. The touch panel 10 has a display portion and an operation receiving portion such as a touch sensor. The touch panel 10 is subjected to display control and operation reception control by the panel control portion 11. That is, the panel control portion 11 performs the display control for the display portion and the operation reception control for the operation receiving portion in the touch panel 10.

On the display portion of the touch panel 10, a current operating state, setting information (for example, sending destination, etc.) and the like are displayed. The display is realized when the panel control portion 11 performs control to display a GUI (Graphical User Interface) image. The GUI enables to change the display and an operation received position depending on a user operation. Each GUI and an image thereof may be stored so as to be readable in an internal memory of the panel control portion 11 or the control memory 19. In addition, as the display portion, display devices in various display systems including liquid crystal displays and organic EL (Electroluminescence) displays are employable.

The user operation received on the touch panel 10 is interpreted by the panel control portion 11 and is transmitted as an operation signal to the main control portion 18. The user operation received by the key operation portion 20 is interpreted by the key operation portion 20 itself and transmitted as an operation signal to the main control portion 18. The main control portion 18 issues a command in accordance with the operation signal obtained in this manner to other parts to cause the other parts to execute processing in accordance with the user operation. Note that, although description has been given with reference to the touch panel 10 in which the display device and the operation portion are integrated, only the display apparatus may be simply provided instead of the touch panel 10 and, in that case, where the user operation is received only by the key operation portion 20.

The touch panel 10 and the key operation portion 20 may be configured as an operation panel 30 as illustrated in FIG. 3, and the operation panel 30 is comprised of a key operation portion 31 (corresponding to the key operation portion 20) provided with various hardware keys and a touch panel 32 (corresponding to the touch panel 10) comprised of a liquid crystal display and a touch sensor. The present invention will hereinafter be described in detail with the touch panel 32 and the key operation portion 31 applied in the configuration of FIG. 1 instead of the touch panel 10 and the key operation portion 20.

The key operation portion 31 is provided with, as hardware keys, a numeric keypad 31a for inputting numeric values, a clear key 31b for clearing input set values, a cancel all key 31c for canceling all of various input settings, and a start key 31d for receiving instructions of start of copying, start of sending, etc., as well as function switch keys 31e, 31f, and 31g for switching a print function, a sending function and a copy function, and a system setting key 31h for receiving a setting by a user.

An exemplary operation in the digital multi-functional peripheral 1 having the above-described exemplary configuration will be described.

### <Original Reading Operation>

An original reading operation is performed when image data of a read original is stored (filed) in the image storage portion 15, when image data of a read original is sent to outside, when image data of a read original is printed (that is, copied), and the like.

When a user operation to perform processing requiring original reading is received by the operation panel 30, the main control portion 18 gives an instruction to the reading portion 13, the image storage portion 15, the image processing portion 16, the coding/decoding portion 17, and the like to execute processing as will be described below.

The reading portion 13 optically reads an image of an original placed on a document platen or an automatic document feeder and provides the image processing portion 16 with RGB image data (bitmap data of RGB) as a result of reading. The image processing portion 16 executes various image processing (hereinafter, referred to as original image processing) such as A/D conversion, shading correction, and γ correction for the RGB image data. Here, the shading processing is processing to remove various distortions generated in an illumination system, an image focusing system, and an image sensing system of the reading portion 13.

As the original image processing, original determination processing and segmentation processing may be executed subsequently to the A/D conversion, the shading correction, and the γ correction. The original determination processing includes processing of determining a type of the original and processing of determining whether the original is a color original or a monochromatic original based on input image data (image data after the application of the γ correction in this case). Examples of the type of the original include a text original, a printed photograph original, and text and printed photograph original in combination thereof. The image processing portion 16 outputs a determination signal (hereinafter, referred to as original determination data) as a result of the original type determination processing and the monochromatic/color original determination processing. The segmentation processing is processing of determining to what kind of area each pixel of the input image data (image data after the application of the γ correction in this case) belongs, and an example thereof includes processing of determining to which area including a black text area, a color text area and a halftone area each pixel belongs. The image processing portion 16 outputs segmentation data as a result of the determination. Note that, the segmentation processing may be executed based on the result of the above-described original determination processing and monochromatic/color original determination processing.

The original determination data and the segmentation data are stored in the image storage portion 15 in association with corresponding image data (image data after the application of the original image processing). At this time, the original determination data and the segmentation data are coded by the coding/decoding portion 17 and each coded data is thereafter stored in the image storage portion 15 in association with the corresponding image data. Note that, although the coding in storing in the image storage portion 15 is not essential, description will be given assuming that the image data is stored in a state of being coded. This is also the same in operations other than the original reading operation.

### <Printing Operation>

By the above-described original reading operation, processing up to filing of the image data of the read original is completed. Next, description will be given for a printing operation when the image data of the read original is printed (that is, when the original is copied). When the user operation to perform processing that requires printing is received by the operation panel 30, the main control portion 18 gives an instruction to the recording portion 12, the image storage portion 15, the image processing portion 16, the coding/decoding portion 17, and the like to execute processing as will be described below. Note that, the main control portion 18 also gives an instruction to the reading portion 13 (original reading instruction), for example, when a copy operation is performed.

The digital multi-functional peripheral 1 is also capable of adding additional information such as a stamp, date (or date and time), and a page number to image data in printing, and when such an adding instruction is given, the main control portion 18 controls the image processing portion 16. It can be said that the additional information added to the image data is an additional image. The additional information is stored in the control memory 19 and is read out as the occasion demands. Of course, the additional information may be originally stored as data of the additional image. In addition, it is recommendable that a plurality of additional information may be stored in the control memory 19 and additional setting information may be stored in the control memory 19. The additional setting information includes at least information showing a position to add to the image data (hereinafter, referred to as an adding position), and when a plurality of additional information is stored, information that indicates any of which is to be selected is also included. Moreover, when an instruction to execute the punching or the stapling by the post processing apparatus is given, the main control portion 18 also controls the post processing apparatus.

The coding/decoding portion 17 reads and decodes image data to be printed and original determination data and segmentation data corresponding thereto from the image storage portion 15, and gives the decoded image data to the image processing portion 16. The image processing portion 16 executes various image processing (hereinafter, referred to as image processing for printing) for the decoded image data (RGB image data). As will be schematically described below, examples of the image processing for printing include image quality adjustment processing, two-color processing, color correction processing, black generation and under color removal processing, spatial filter processing, scaling processing, output tone correction processing, and halftone generation processing. The black generation and under color removal processing, the spatial filter processing, and the halftone generation processing are processing in accordance with various areas indicated by the segmentation data.

As the image quality adjustment processing, a background is detected from the decoded image data to perform background removal. Moreover, as the image quality adjustment processing, RGB adjustment (color adjustment; entire color adjustment of redness or blueness), brightness adjustment, and vividness adjustment are also performed for the image data after the application of the background removal based on setting information set by a user from the operation panel 30. At this time, adjustment in accordance with an original type indicated by the original determination data may be performed.

As the color correction processing, CMY data having components of CMY (C: Cyan, M: Magenta, Y: Yellow) which are complementary colors of RGB is generated from the RGB data after the application of the image quality adjustment processing and the processing of enhancing color reproduction is performed. As the black generation and under color removal processing, black generation processing of generating black (K) data from the CMY data after the application of the color correction and under color removal processing of subtracting the K data obtained by the black generation from the original CMY data to generate new CMY data. As the spatial filter processing, enhancement processing or smoothing processing is performed for CMYK data which is data of the four colors. When a two-color mode for outputting the image data in two colors (for example, red and black) is selected, the two-color processing is performed. As the two-color processing, processing of converting the RGB data into CMY data that represents specified two colors (red and black in this case) is performed. In the case of the two-color mode, the black generation and under color removal processing is executed for the CMY data after the application of the two-color processing and the spatial filter processing is also executed, however, the color correction processing is not performed.

As the scaling processing, image enlarging processing or image reducing processing is performed for the CMYK data after the application of the spatial filter processing based on a printing copy ratio set by the user operation from the operation panel 30. The printing copy ratio is a copy ratio of a printed image for the image indicated by read and stored image data. Of course, the printing copy ratio is not limited to a copy ratio obtained by the user operation and is a copy ratio set as default when no operation is performed for the printing copy ratio. As the output tone correction processing, output γ correction processing of outputting to a recording medium such as recording paper is performed for the CMYK data. As the halftone generation processing, tone reproduction processing of outputting an image by error diffusion processing and dither processing is performed for the CMYK data after the application of the output tone correction processing. In the output tone correction processing and the halftone generation processing, the processing in accordance with an original type indicated by the original determination data may be performed, for example, including differentiating processing contents between a text area and other areas.

The CMYK data after the application of the halftone generation processing is provided to the recording portion 12. Description will be given for the case where additional information is added. There are a method for applying the scaling processing also to the additional information in accordance with a magnification of print data and a method for not applying the scaling processing to the additional information regardless of a magnification of print data. First, when the scaling processing is also performed for the additional information, the main control portion 18 reads the additional information and information showing an adding position, the main control portion 18 or the image processing portion 16 converts into image data as the occasion demands, and the image data of the additional information is provided to the image processing portion 16 before the scaling processing. Note that, the conversion is not necessary when additional image data is originally stored. Subsequently, the image processing portion 16 may combine the image data of the additional information and image data of an addition destination that is image data before the scaling processing at the above-described adding position.

When the scaling processing is not performed for the additional information, the main control portion 18 reads the additional information and information showing an adding position, and the main control portion 18 or the image processing portion 16 converts into image data as the occasion demands. In this example, CMYK data is obtained by the conversion. Note that, the conversion is not necessary when additional image data is originally stored. Subsequently, the image processing portion 16 may combine the image data of the additional information and image data of an addition destination that is image data after the application of the scaling processing (the above-described CMYK data to which the output tone correction processing or the halftone generation processing is applied) at the above-described adding position.

In either case, it is possible to output CMYK data after the application of the halftone generation processing with the additional information added thereto by the image processing portion 16. Note that, in the digital multi-functional peripheral 1, additional information and an adding position thereof can be set by the user using the operation panel 30 while performing a preview display described below.

The recording portion 12 receives the image data to which the image processing for printing has been given by the image processing portion 16 in this manner (CMYK image data in this example) and generates a hard copy (prints out) by an electrophotographic system, an inkjet system, or the like. Then, the post processing apparatus executes the punching or the stapling for printed sheets as the occasion demands. Note that, the data targeted for the printing operation described here is not limited to the image data read by the reading portion 13, and, for example, image data (image file) that has been previously transferred from an external recording medium, a PC connected through a network, or the like and stored in the image storage portion 15 is also applicable in the same manner. The printing operation for the image data that has been received by facsimile and stored in the image storage portion 15 will be described below.

### <Preview Display Operation for Image Data to be Printed>

Next, description will be given for an operation of displaying a preview of image data stored in the image storage portion 15 as a result of original reading on the touch panel 32 before printing (preview display operation). The digital multi-functional peripheral 1 is configured so as to allow image data to be printed to be displayed for previewing (thumbnail display). The preview display operation is performed when the user operation to perform processing that requires the preview display is received by the operation panel 30. For example, the preview display operation is also performed when a setting is made such that a preview of the image data after the original reading is firstly displayed before executing printing.

The main control portion 18 gives an instruction to the image storage portion 15, the image processing portion 16, the coding/decoding portion 17, the panel control portion 11, and the like to execute processing as will be described below. Note that, the main control portion 18 also gives an instruction to the reading portion 13 (original reading instruction), for example, when an operation of copying an original is performed.

The coding/decoding portion 17 reads and decodes image data to be displayed for previewing and original determination data and segmentation data corresponding thereto from the image storage portion 15, and gives the decoded data to the image processing portion 16. The image processing portion 16 executes various image processing (hereinafter, referred to as image processing for previewing) for the decoded image data (RGB image data). As will be schematically described below, examples of the image processing for previewing include image quality adjustment processing, two-color processing, color correction processing, spatial filter processing, scaling processing, and output tone correction processing. The spatial filter processing and the output tone correction processing are processing in accordance with various areas indicated by the segmentation data.

The image quality adjustment processing here is the same as the image quality adjustment processing in the image processing for printing. As the color correction processing, processing of converting the image data after the application of the image quality adjustment processing (RGB data) into R′G′B′ data based on display characteristics of the touch panel 32. As the spatial filter processing, enhancement processing or smoothing processing is performed for the R′G′B′ data.

As the scaling processing, image enlarging processing/image reducing processing in accordance with the printing copy ratio is performed to R′G′B′ data after the application of the spatial filter processing, and further processing to convert a pixel number of the R′G′B′ data into a pixel number (display resolution) of the touch panel 32 is performed and the image enlarging processing or image reducing processing is performed based on a preview display magnification set by the user operation from the operation panel 30 at the same time. The preview display magnification is a fixed magnification, for example, such as twice or four times, and is a magnification of an image in the preview display. Of course, the preview display magnification is not limited to a preview display magnification obtained by the user operation and is a preview display magnification set as default when no operation is performed for the preview display magnification.

A preview image generating portion 16a provided in the image processing portion 16 generates an image for the preview display (preview image) mainly by such scaling processing for the preview display.

Description will be given for a preview image in a case where additional information is added. When image data of the object to output is output with additional information added thereto in the digital multi-functional peripheral 1 of the present invention, the panel control 11 controls to display an additional information image showing additional information. Accordingly, the preview image generating portion 16a generates such an additional information image and superimpose it on a preview image generated from the image data of the object to output to generate a preview image with an additional information image.

The additional information can be output together with image data to be printed by performing the scaling processing in accordance with a printing copy ratio and, furthermore, can be output by adding to the image data to be printed after that information is subjected to the scaling processing in accordance with a printing copy ratio. First, when the scaling processing is performed also to the additional information to output, the main control portion 18 reads the adding position of the additional information and the information showing the additional information (or a size of the additional information) and gives the position and the information to the image processing portion 16 before the scaling processing. Subsequently, the preview image generating portion 16a generates R′G′B′ data of an additional information image showing the additional information from the additional information (or the size of the additional information), combines the generated data with image data of an addition destination that is the image data before the scaling processing is performed at the above-described adding position. Then, the image enlarging processing/image reducing processing in accordance with a printing copy ratio may be applied to the R′G′B′ data to which the additional information image has been added.

When the scaling processing is not performed to the additional information, the main control portion 18 reads the adding position of the additional information and the information showing the additional information (or a size of the additional information) and gives the position and the information to the image processing portion 16. Subsequently, the preview image generating portion 16a generates R′G′B′ data of an additional information image showing the additional information from the additional information (or the size of additional information), combines the generated data with the R′G′B′ data after the application of the image enlarging processing/image reducing processing in accordance with a printing copy ratio at the above-described adding position, and performs processing to convert the number of pixel of the R′G′B′ data to which the addition has been performed into the number of pixel (display resolution) of the touch panel 32, and at the same time, the image enlarging processing or the image reducing processing may be performed based on the preview display magnification set by the user operation from the operation panel 30.

Furthermore, when the punching or the stapling is applied in the post-processing apparatus, data of an image for showing post processing such as punching holes and stapling (for convenience, referred to as “an additional information image”) may be output by being combined with a preview image generated from image data to be printed (and additional information image data of additional information) at a punching position or a stapling position. Such processing enables displaying an output state of a sheet on which an image is formed as the time of displaying a preview of the image data.

As the output tone correction processing, output γ correction processing is performed to R′G′B′ data of the preview image with the additional information image added thereto to display the image data on the touch panel 32. In the output tone correction processing, processing may be performed in accordance with an original type indicated by the original determination data, for example, different processing is performed to a text area and other areas respectively.

The two-color processing is executed only when a two-color mode for outputting image data in two colors of red and black, for example, is selected. As the two-color processing, processing of converting the RGB data after the application of the image quality adjustment processing into CMY data that represents specified two colors (red and black in this case) is performed. The generated CMYK data is converted into R′G′B′ data based on display characteristics of the touch panel 32 at the subsequent color correction processing.

R′G′B′ data generated by the preview image generating portion 16a and subjected to the output tone correction processing is given to the touch panel 32. The panel control portion 11 performs a control for the touch panel 32 to display an image corresponding to the R′G′B′ data by incorporating it in a GUI image and displays the GUI image on the touch panel 32. A user confirms an image displayed for previewing including an additional information image showing additional information or post processing, and determines whether to execute printing as it is or to cancel, whether to delete the additional information or to suspend the post processing, whether to execute changing of the adding position (or changing of the additional information) or changing of a post processing position, and is able to perform the operation awaiting to the results of the determination.

Note that, the data targeted for the preview display operation described here is not limited to the image data read by the reading portion 13, and, for example, image data (image file) that has been previously transferred from an external recording medium, a PC connected through a network, or the like and stored in the image storage portion 15 is also applicable in the same manner. The preview display operation for the image data that has been received by facsimile and stored in the image storage portion 15 will be described below.

### <Supplementary on Original Reading, Preview Display and Printing>

Although the preview display operation is described separately from the printing operation, image data after the application of the output tone correction processing (CMYK data) may be, first as the printing operation, converted into R′G′B′ data based on display characteristics of the touch panel 32, and the conversion processing corresponding to the number of pixels (display resolution) of the touch panel 32 and the scaling processing in accordance with a reducing/enlarging ratio in displaying a preview may be performed to display on the touch panel 32. It is useful, since the printing operation is completed to a certain degree and the printing operation can thereby be quickly completed after the preview display, for example, in a case where setting is made such that the preview display is previously performed when the copying operation is performed. Such processing is also applicable to the case of displaying a preview with an additional information image showing additional information and post processing added thereto.

In addition, an example in which the coded image data, the original classification data and the segmentation data are stored in the image storage portion 15 in association with one another has been taken as the original reading operation, and the printing operation and the preview display operation have been also described based on the example. As an alternative method thereof, coding may be performed only for the image data read by the reading portion 13, and the coded image data may be temporarily stored in the image storage portion 15. In this case, it may be configured such that the image processing portion 16 applies the original type determination processing and the segmentation processing to the image data that has been read from the image storage portion 15 and decoded by the coding/decoding portion 17 in the printing operation and the preview display operation. In addition, such an alternative method is also applicable in sending image data such as facsimile sending or internet FAX sending, which will be described below.

### <Printing Operation for Image Data Received by Facsimile>

Next, description will be given for the printing operation for image data received by facsimile communication. When detecting a facsimile communication request by the modem 24, the main control portion 18 gives an instruction to the recording portion 12, the image storage portion 15, the image processing portion 16, the NCU 23, the modem 24, and the like to execute processing as will be described below.

First, the modem 24 and the NCU 23 sequentially receive image data (compressed image data) sent from a sending source according to the communication procedure and expand the received compressed image data, and execute rotating processing (processing of rotating a sending direction), resolution conversion processing, and the like as necessary to provide to the image processing portion 16 at the same time.

Since the image data received by facsimile communication is black-and-white binary data, particular processing is not performed for the image data (K data) to which processing such as expansion has been given in the image processing portion 16, and the image data is directly given to the recording portion 12. The recording portion 12 receives the image data and executes printing by an electrophotographic system, an inkjet system, or the like. It is also possible to perform printing for the image data received by facsimile communication after adding the above-described additional information thereto.

Description has been given for the facsimile reception of the monochromatic image, but when a color facsimile image (RGB data) is received, the image processing portion 16 may execute the image processing for facsimile reception described here for the RGB data.

### <Preview Display Operation of Image Data Received by Facsimile>

Description will be given briefly for the preview display operation of image data received by facsimile communication based on the printing operation of the same image data. The preview display operation is performed when a previous setting or a user operation is made such that printing is executed after the image data received is previously confirmed. In the preview display operation, the image processing portion 16 combines, in the case of adding additional information or applying post processing, the image data of an additional information image showing the additional information or the post processing with the image data to which the processing such as expansion has been applied, and after that further performs the conversion processing in accordance with the number of pixels (display resolution) of the touch panel 32 and the scaling processing in accordance with a reducing/enlarging ratio at the time of displaying a preview, and then the image data after the application of the scaling processing is displaced on the touch panel 32. The user confirms the image displayed for previewing, determines whether to execute or discard printing, contents and necessity of the additional information and the post processing, and is able to perform printing or discarding operation, or the operation to change the contents of the additional information or the post processing.

### <Facsimile Sending Operation>

Next, description will be given for a sending operation when image data of a read original is sent by facsimile. The facsimile image data is sent to destination (sending destination) information set by the user operation from the touch panel 32 or the key operation portion 31. The destination information (telephone number in this example) is stored in the control memory 19 and is read out as necessary. The destination information is generally stored as address book data so that information of each of a plurality of destinations is viewable and selectable, or is directly input before sending.

When the user operation to execute the facsimile sending is received by the operation panel 30, the main control portion 18 gives an instruction to the image storage portion 15, the image processing portion 16, the coding/decoding portion 17, the NCU 23, the modem 24, and the like to execute processing as will be described below. Note that, the main control portion 18 also gives an instruction to the reading portion 13 (original reading instruction), for example, when the operation to send the original by facsimile is performed. Note that, it is also possible for the main control portion 18 to select image data to be sent and start to send it by facsimile as it displays a preview of the image data stored in the image storage portion 15.

The coding/decoding portion 17 reads and decodes image data to be printed and original determination data and segmentation data corresponding thereto from the image storage portion 15 and gives the coded data to the image processing portion 16. The image processing portion 16 executes various image processing (hereinafter, referred to as image processing for facsimile sending) for the decoded image data (RGB image data). As will be schematically described below, examples of the image processing for facsimile sending include image quality adjustment processing, spatial filter processing, scaling processing, output tone correction processing, and halftone generation processing. The spatial filter processing and the halftone generation processing may be processing in accordance with various areas indicated by the segmentation data, while it is possible not to use the segmentation data. Further, in the original reading operation following the facsimile sending, the segmentation processing for the read image data and coding and storage of the segmentation data may not be executed.

As the image quality adjustment processing, the decoded image data is converted into K data using a matrix coefficient. In this case, a matrix coefficient in accordance with an original type indicated by the original determination data may be used. As the spatial filter processing, enhancement processing or smoothing processing is performed for the K data. As the scaling processing, image enlarging processing or image reducing processing in accordance with a sending resolution set by the operation panel 30 or a default-set sending resolution is performed for the K data spatial filter processing. As the output tone correction processing, output γ correction processing for the purpose of outputting to a recording medium such as recording paper at a sending destination, for example, is performed to the K data after the application of the scaling processing. Actually, it is possible to perform output γ correction to a general device but not output γ correction that takes a device of the sending destination into consideration. As the halftone generation processing, binarization by error diffusion processing, for example, is performed for the K data after the application of the output tone correction processing. In the output tone correction processing and the halftone generation processing, processing in accordance with an original type indicated by the original determination data may be performed.

Description has been given for the facsimile sending of the monochromatic image, but when a color image is sent by facsimile, the image processing portion 16 may perform processing of converting the decoded image data into L*a*b* data for color transmission using a matrix coefficient as the image quality adjustment processing in the above-described image processing for facsimile sending so that the subsequent processing is performed for the L*a*b* data.

The rotating processing is applied to the image data after the application of the halftone generation processing as the occasion demands and the image data after the application of the halftone generation processing is compressed and coded by the coding/decoding portion 17 in a compression format at the facsimile sending, and then temporarily saved in the image storage portion 15. The modem 24 performs sending procedure to a sending destination set through the NCU 23, and at the time when communication with the sending destination is established (at the time ready for sending), the coded K data which is temporarily saved is read out and sequentially sent to the sending destination through the public line network after the application of necessary processing such as changing of the compression format.

In addition, the digital multi-functional peripheral 1 is also capable of sending image data to be sent with additional information added thereto. When sending image data to the outside like in this example, it is also possible to add sending source information (transmission source information) in addition to a stamp, date (date and time), and a page number as the additional information. In this case, the sending source information that is added in sending image data may include any one or more pieces of information of a name of a sender, information of a telephone number of a sending source, and information of an electronic mail address of a sending source. Moreover, information of a sending destination (information of a destination) and the like may be added as the additional information in sending image data.

In the case of the facsimile sending with additional information added, combining processing may be performed as follows. The main control portion 18 reads additional information and information showing an adding position, the main control portion 18 or the image processing portion 16 converts the information into image data, and the image processing portion 16 combines the converted image data (image data of additional information) and image data of an addition destination that is image data after the application of the scaling processing at the above-described adding position. In the digital multi-functional peripheral 1, the position at which the image data of the additional information is added is possibly set by a user from the operation panel 30 as the user performs the preview display as will be described below. The combined image data is sent to the sending destination after the above-described output tone correction processing, rotating processing, and compression processing, etc., are applied to it.

### <Preview Display Operation for Image Data to be Sent by Facsimile>

The digital multi-functional peripheral 1 is configured so as to be possible to display image data to be sent by facsimile sending or the like for previewing. The preview display operation is performed, for example, when the previous setting or the user operation to execute sending after the confirmation of the image data before sending in advance is performed. Description will be given for the preview display operation for the image data to be sent by facsimile based on the facsimile sending operation for the same image data. In the preview display operation, the main control portion 18 also gives an instruction to the panel control portion 11.

In the preview display operation, it is preferable for the image processing portion 16 to perform the same processing as that in the facsimile sending up to the image quality adjustment processing, the spatial filter processing (and scaling processing), execute preview image generation processing by the preview image generating portion 16a and perform, as the output tone correction processing, the output γ correction processing to display image data. As the preview image generation processing, the preview image generating portion 16a performs, to image data after the application of the image enlarging processing or the image reducing processing in accordance with a sending resolution, the conversion processing in accordance with the number of pixels (display resolution) of the touch panel 32 and the scaling processing in accordance with a reducing/enlarging ratio in displaying a preview, so that data for the preview image is generated. Note that, in the preview display operation, the spatial filter processing may not be executed and the halftone generation processing is not executed.

R′G′B′ data generated by the preview image generating portion 16a and dealt with by means of the output tone correction processing is given to the touch panel 32. The panel control portion 11 performs control for the touch panel 32 to display an image corresponding to the R′G′B′ data in a state of being incorporated in a GUI image and displays the GUI image on the touch panel 32.

Description will be given for a preview image in the case of sending it with additional information added thereto. The additional information is output by adding it to the image data subjected to the scaling processing in accordance with a sending resolution. More specifically, the main control portion 18 reads an adding position of the additional information and the additional information, and gives the position and the additional information to the image processing portion 16. Subsequently, the preview image generating portion 16a generates R′G′B′ data of an additional information image showing additional information from the additional information and may combine the generated R′G′B′ with the R′G′B′ data after the application of the image enlarging processing or the image reducing processing in accordance with a sending resolution at the above-described adding position. Note that, in sending image data such as facsimile sending, the post processing is not particularly considered.

The image data with the additional information image combined in this manner is, after the application of the output tone correction processing (output γ correction processing to display image data) in the above-described preview display, incorporated by the panel control portion 11 in a GUI image and displayed on the touch panel 32. The user confirms the image displayed for previewing including the additional information image, determines whether to execute or cancel the facsimile sending, whether to delete the additional information, whether to execute changing of the adding position (or changing of the additional information), or the like, and is able to perform the operation according to the results of the determination.

### <Sending Operation for Image Data Via Internet>

Next, description will be given for a sending operation when image data of a read original is sent by an electronic mail or internet FAX via the internet. Such image data to be sent via the internet is also sent to sending destination information (electronic mail address in this example) set by the user operation from the touch panel 32 or the key operation portion 31 and stored in the control memory 19.

When the user operation concerning the sending via the internet is received by the operation panel 30, the main control portion 18 gives an instruction to the format converting portion 14, the image storage portion 15, the image processing portion 16, the coding/decoding portion 17, the LAN control portion 21, and the like to execute sending processing via the internet as will be described below. Note that, the main control portion 18 also gives an instruction to the reading portion 13 (original reading instruction), for example, when an operation to send an original via the internet is performed.

The coding/decoding portion 17 reads and decodes image data to be printed and original determination data and segmentation data corresponding thereto from the image storage portion 15, and gives the decoded data to the image processing portion 16. The image processing portion 16 executes various image processing (hereinafter, referred to as image processing for internet sending) to the decoded image data (RGB image data). Examples of the image processing for internet sending include the image quality adjustment processing, the spatial filter processing, the scaling processing, the output tone correction processing, and the halftone generation processing, which have been described in the image processing for facsimile sending.

Moreover, the image processing in the case of color image sending is also the same as the image processing for facsimile sending, and in the image processing for internet sending, the image processing portion 16 may perform processing of converting the decoded image data into L*a*b* data for color transmission using a matrix coefficient as the image quality adjustment processing so that the subsequent processing is performed for the L*a*b* data.

The coding/decoding portion 17 codes (compresses) the image data after the application of the image processing for internet sending to obtain compressed files. The compression is performed in the unit of a single page of the original. Subsequently, the format converting portion 14 converts the compressed files into a single file and the file is attached to a multipart mail according to MIME (Multipurpose Internet Mail Extension), for example. By the processing so far, the read image data is converted into a format of an electronic mail. The electronic mail is sent to a sending destination via the internet using a mail transfer protocol such as an SMTP (Simple Mail Transfer Protocol) through a LAN interface by the LAN control portion 21.

In the case of the internet facsimile sending, the coding/decoding portion 17 may perform the compression in a compression format only for facsimile such as MH, for example, and the format converting portion 14 may convert the obtained compressed files in the unit of a page, for example, into a single TIFF file. In the case of sending just by attaching to the electronic mail as an attached file (in the case of sending by so-called scan to e-mail), the coding/decoding portion 17 may perform the compression in a compression format such as JPEG, for example, and the format converting portion 14 may convert the obtained compressed files in the unit of a page into a single PDF file, for example.

In addition, even when image data to be sent is image data sent via the internet, the digital multi-functional peripheral 1 is capable of sending the image data with additional information added thereto in the same manner as the case of the facsimile sending image data. As the additional information adding processing, the combining processing described in the facsimile sending may be executed, and the image data is subjected to the output tone correction processing, the compression processing, the format conversion processing, and the like described above and thereafter sent to an address of a sending destination as an electronic mail.

### <Preview Display Operation for Image Data to be Sent Via Internet>

As mentioned in the description for the preview display in the facsimile sending, the digital multi-functional peripheral 1 of the present invention is capable of being configured so that a preview of image data to be sent via the internet is also able to be displayed on the touch panel 32.

In the preview display operation, as mentioned in the description for the preview display in the facsimile sending, it is preferable for the image processing portion 16 to perform the same processing as the image processing for the internet sending up to the image quality adjustment processing, the spatial filtering processing (and the scaling processing), execute the preview image generation processing by the preview image generating portion 16a and perform, as the output tone correction processing, the output γ correction processing to display image data. The R′G′B′ data generated by the preview image generating portion 16a and subjected to the output tone correction processing is given to the touch panel 32, is incorporated by the panel control portion 11 in a GUI image and is displayed on the touch panel 32. Further, addition of the additional information image is also possible to be described by using the description for the preview display in the facsimile sending.

### <Description of Preview Display Before Outputting (Sending or Printing) Image Data According to the Present Invention>

As has been described hereinbefore the preview display operation before printing in copying or in facsimile reception and has been described the preview display operation in facsimile sending or in sending image data through the internet, the digital multi-functional peripheral 1 according to the present invention has the preview image generating portion 16a that reads image data that is the object of the output from the image storage portion 15 and generates a preview image thereof. The preview image generated by the preview image generating portion 16a is sent to the touch panel 32 by the control of the main control portion 18, is controlled by the panel control portion 11 to be displayed in a state of being incorporated in a GUI image, and is displayed on the touch panel 32. In this manner, the touch panel 32 is an example of the image display portion for displaying a preview of the image data of the object to output.

Here, the image data of the object to output may be image data input from any of a scanner apparatus illustrated in the reading portion 13, an attachable/detachable storage apparatus illustrated in the USB memory connected to the USB I/F 25, and a communication line illustrated in the LAN or the line. Alternatively, the image data of the object to output may be image data read from a storage apparatus illustrated in the image storage portion 15 provided in the digital multi-functional peripheral 1.

As has been described above, the digital multi-functional peripheral 1 according to the present invention is capable of outputting image data of the object to output with additional information added thereto, or of printing the image data of the object to output on recording paper and applying the post processing to the recording paper. Note that, the digital multi-functional peripheral 1 may be configured such that only one of either addition of the additional information or the post processing is executable.

Furthermore, as has been described above, in the digital multi-functional peripheral 1 of the present invention, the panel control portion 11 performs a control based on the control of the main control portion 18 to display an additional information image showing the additional information and the post processing on the touch panel 32. Accordingly, the preview image generating portion 16a generates such an additional information image and combines it with a preview image generated from image data of the object to output, to generate a preview image with the additional information image added thereto. A combining position is a position of the preview image corresponding to an adding position of the additional information or a position at which the post processing is applied.

The main characteristic of the present invention is that the panel control portion 11 performs the control to enlarge a part where the additional information image is combined (combined part) to display on the touch panel 32. Such a display in enlargement may be executed in a first preview display, for example, or may be executed by selecting a key such as “output display” in a preview display not showing the additional information image. In a preview image with the additional information image added thereto, the additional information image is a characteristic part. Accordingly, a preview display of enlarged additional information image means that the characteristic part of the preview image is displayed at a position that is visually identified easily. Furthermore, as a general preview display processing, a preview image is displayed such that upper left thereof is aligned with upper left of a preview display region of the touch panel 32, and the like, but in the present invention, since the characteristic part is displayed at a position that is easily recognized, the display position of the entire preview image with the additional information image added thereto is displayed by being shifted from the upper left position. However, such entire shifting is not necessary in a case where the additional information image originally lies in upper left.

The preview image generating portion 16a and the panel control portion 11 is an example of a display control portion, which performs a control for an image display portion to display a combined part with the additional information image combined in enlargement in displaying a preview.

By such a configuration of the present invention, when image data that is the object of the output is output with additional information added thereto or when a recording medium is output after the application of post processing such as punching or stapling, it is possible, without requiring troublesome user operations such as enlarging, reducing or shifting to confirm, in displaying a preview, the characteristic part such as additional information to be added or post processing to be applied easily and a final state of image formation reliably. That is, according to the present invention, even when the additional information such as a stamp, date, a page number is added to image data or the post processing is applied in outputting, a position relationship between such additional information or post processing and the image data can be confirmed easily and the position relationship can be adjusted based on the confirmation on a preview display screen.

### <Specific Example of Preview Display>

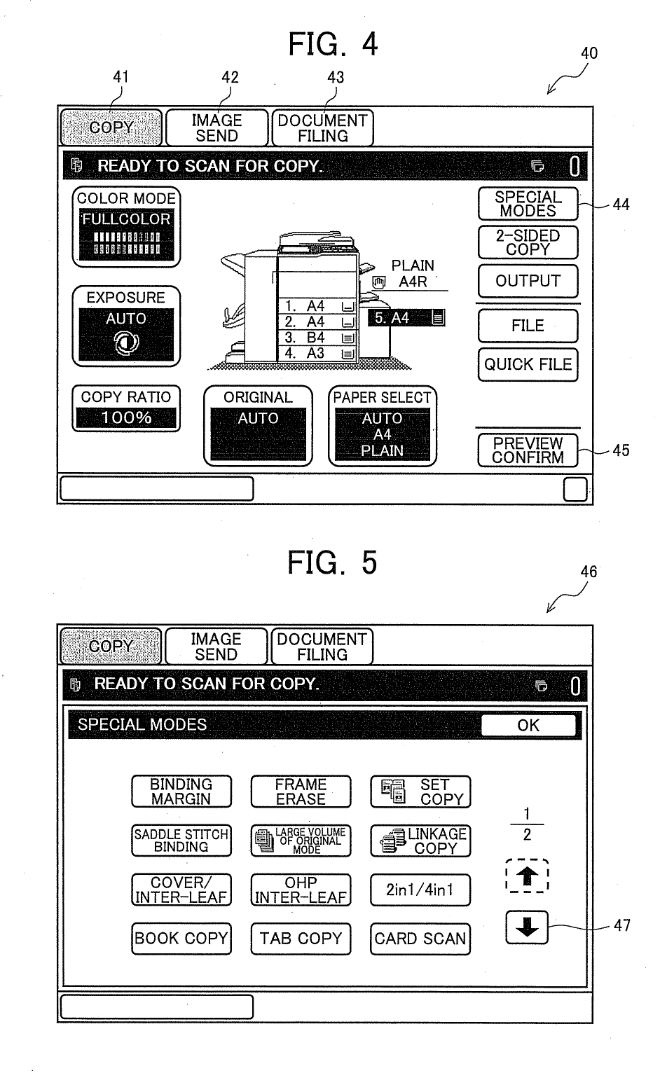

Referring to FIGS. 4 to 26B, description will hereinafter be given for an additional information image showing additional information to be added to an image data of the object to output or post processing, and for a flow of the preview display thereof with specific examples thereof. An example below cites printing in copying mainly as an example, however, as described above, it is similar in printing when receiving a facsimile, in printing of image data read from a USB memory or the like, in facsimile sending, in internet FAX sending and reception, or the like.

FIG. 4 is a diagram for showing an example of a standard screen of the digital multi-functional peripheral explained in FIGS. 2 and 3. FIG. 4 shows an example of a GUI image (referred to as a GUI image 40) displayed on the touch panel 32 in the digital multi-functional peripheral 1 as the standard screen. The GUI image 40 of the standard screen is displayed on the touch panel 32 when a power source of the digital multi-functional peripheral 1 is turned on or reset. In the GUI image 40, a copy mode selection key 41, an image send mode selection key 42, and a document filing mode selection key 43 are displayed to select an operation mode of the digital multi-functional peripheral 1, and the GUI image 40 shows a state where the copy mode is selected.

In the copy mode, various condition settings are possible to perform a copy. For example, a 2-sided copy key for performing a setting of 1-sided/2-sided copy, a finish key for performing a setting of post processing such as punching or stapling, a special modes key 44 for performing other detailed settings in copying, a preview confirm key 45 for confirming a finish state of an image read by a scanner, an image input from an external device, or an image stored in a storage apparatus such as HDD or the like, a finish key for setting finish processing (post processing) such as punching or stapling, and the like, are provided. The user is able to display a preview of image data by operating the preview confirm key 45 using the touch panel 32. Note that, the key 42 or the key 43 is selected to shift a mode to an image send mode or a document filing mode, and at this time, a GUI image for setting in each mode is displayed so that various settings in accordance with each mode can be performed.

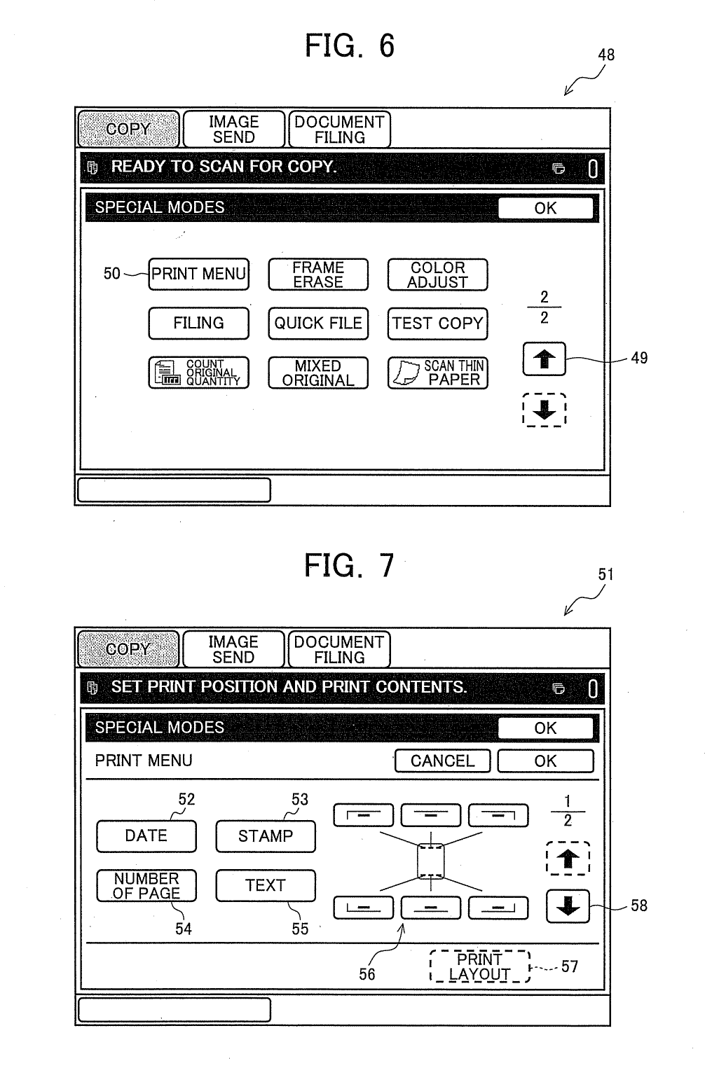

FIG. 5 is a diagram for showing an example of a GUI image displayed when the special modes key for a detailed setting in copying is selected in the GUI image of FIG. 4, and FIG. 6 is a diagram for showing an example of a GUI image displayed when an arrow key is selected in the GUI image of FIG. 5. Note that, although description will not be given individually to each example, an OK key and a cancel key are displayed in the diagrams described below including FIGS. 5 and 6, and after depressing the OK key, returning to a previous screen is possible by storing the setting thereof, for example, and after depressing the cancel key, returning to a previous screen is possible, for example, by cancelling the setting thereof.

In a GUI image 46 shown in FIG. 5, various setting items such as a binding margin, a binding in middle position and the like are displayed so as to be selectable, and since there are many setting items, an arrow key 47 is displayed. By selecting the arrow key 47, like in a GUI image 48 of FIG. 6, other setting items are displayed so as to be selectable. In the GUI image 48, a print menu key 50 or the like is displayed as other setting items so as to be selectable and an arrow key 49 for returning to the GUI image 46 is also displayed.

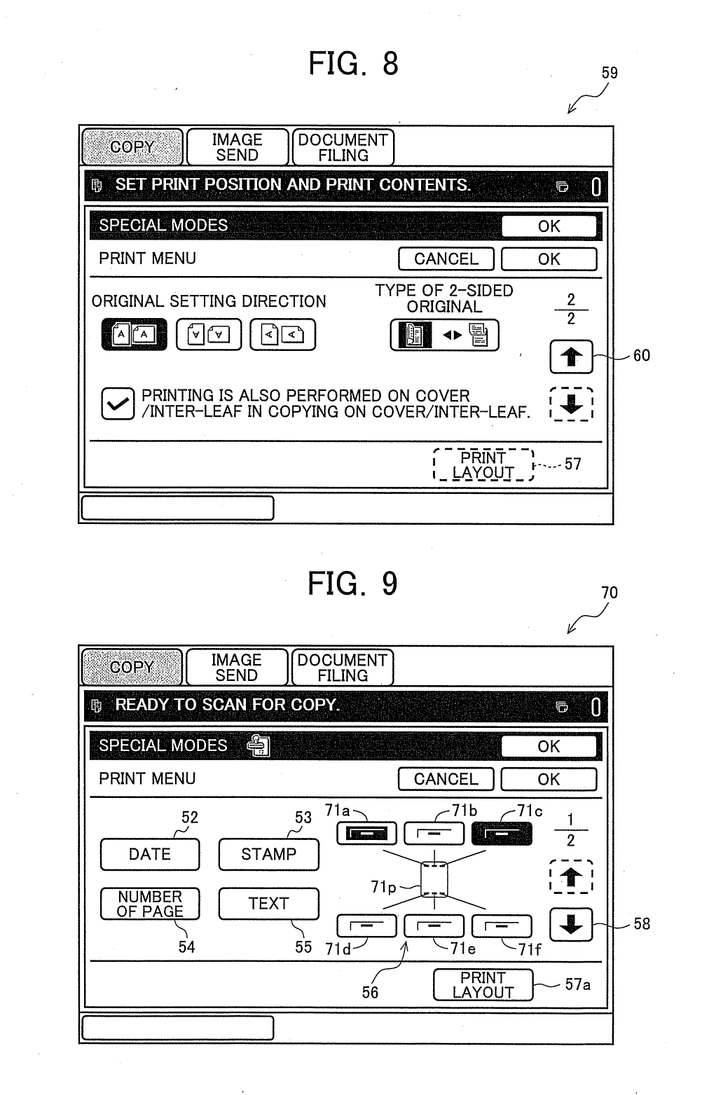

FIG. 7 is a diagram for showing an example of a GUI image displayed when the print menu key has been selected in the GUI image of FIG. 6, and FIG. 8 is a diagram for showing an example of a GUI image displayed when the arrow key has been selected in the GUI image of FIG. 7. A GUI image 51 shown in FIG. 7 is displayed by selecting the print menu key 50 of FIG. 6, and thus contents of additional information to be added in printing are possible to be set.

In the GUI image 51 shown in FIG. 7, a date key 52, a stamp key 53, a number of page key 54, and a text key 55 are displayed so as to be selectable. The date key 52 is a key for inputting and setting a date, the stamp key 53 is a key for setting a fixed stamp such as “IMPORTANT” or “TOP SECRET”, the number of page key 54 is a key for setting a page number to be printed on recording paper, and the text key 55 is a key for inputting text desired by a user as additional information.

In addition, on the right side of these four keys 52 to 55, an additional information confirmation image 56 is displayed for confirming at which position (upper left, upper middle, upper right, lower left, lower middle, or lower right) in recording paper each of additional information including “date”, “stamp”, “page number” and “text” is to be set or has been set. The additional information confirmation image 56 in FIG. 7 shows a state where additional information is not set in any position. In the GUI image 51, since there is a state where no additional information is set, a print layout key 57 described below is displayed in a state where selection is impossible. An image after setting additional information will be described below with reference to FIG. 9, for example.

In the GUI image 51 shown in FIG. 7, since there are many setting items related to additional information, an arrow key 58 is also displayed. By selecting the arrow key 58, other setting items are displayed like in the GUI image 59 of FIG. 8. In the GUI image 48, a setting direction of an original (portrait/landscape), a type of a 2-sided original (laterally-opened 2-sided original/longitudinally-opened 2-sided original), and presence/absence of a stamp print on an interleaf are displayed so as to be settable, and an arrow key 60 for returning to the GUI image 51 is also displayed.

FIG. 9 is a diagram for showing another example of the GUI image displayed when the print menu key has been selected in the GUI image of FIG. 6, and the diagram shows an example of the GUI image in a case where additional information is set. In the GUI image 70 shown in FIG. 9, the additional information confirmation image 56 is, different from that of FIG. 7, an image showing a state where additional information is set. To explain more specifically, each adding position (upper left, upper middle, upper right, lower left, lower middle, or lower right) to an image (recording paper image) 71p corresponding to recording paper is displayed to be shown, and state presentation images 71a to 71f for showing a setting state relating to each adding position are displayed, and in FIG. 9, at least one among the images 71a to 71f (the upper left side shown by the image 71a in this example) shows a state where additional information is set. Additionally, in the GUI image 70, a print layout key 57a is also displayed so as to be selectable.

Description will be given here for a method of distinguishing a setting state in the state presentation images 71a to 71f illustrated in FIG. 9. A printing position of which the print menu has not yet been set and not yet been selected, is displayed in not-reverse like the state presentation images 71b, 71d, 71e or 71f. The printing position currently being selected is displayed in full reverse like the state presentation image 71c. The printing position of which other print menu has already been set, like the state presentation image 71a, only the inside of the key is displayed in reverse. When selecting a position at which print contents are not set, the selected position is displayed in full-reverse, and when a print setting has not been set for the key previously selected, the not-reverse display is shown, and when print setting has been performed, the inside reverse display is shown.

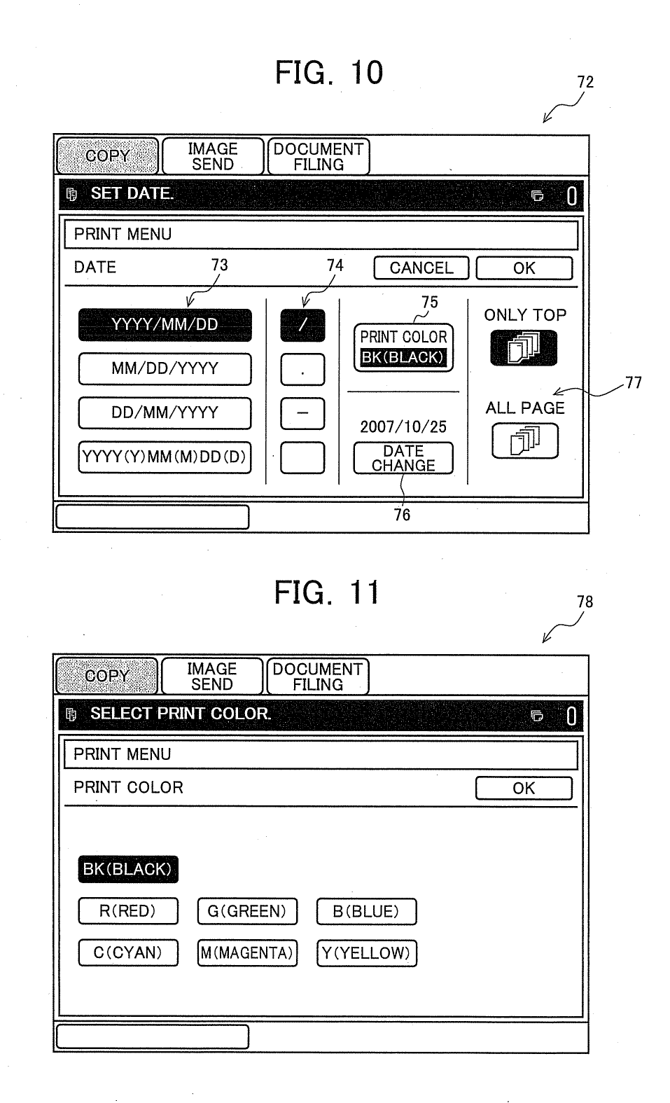

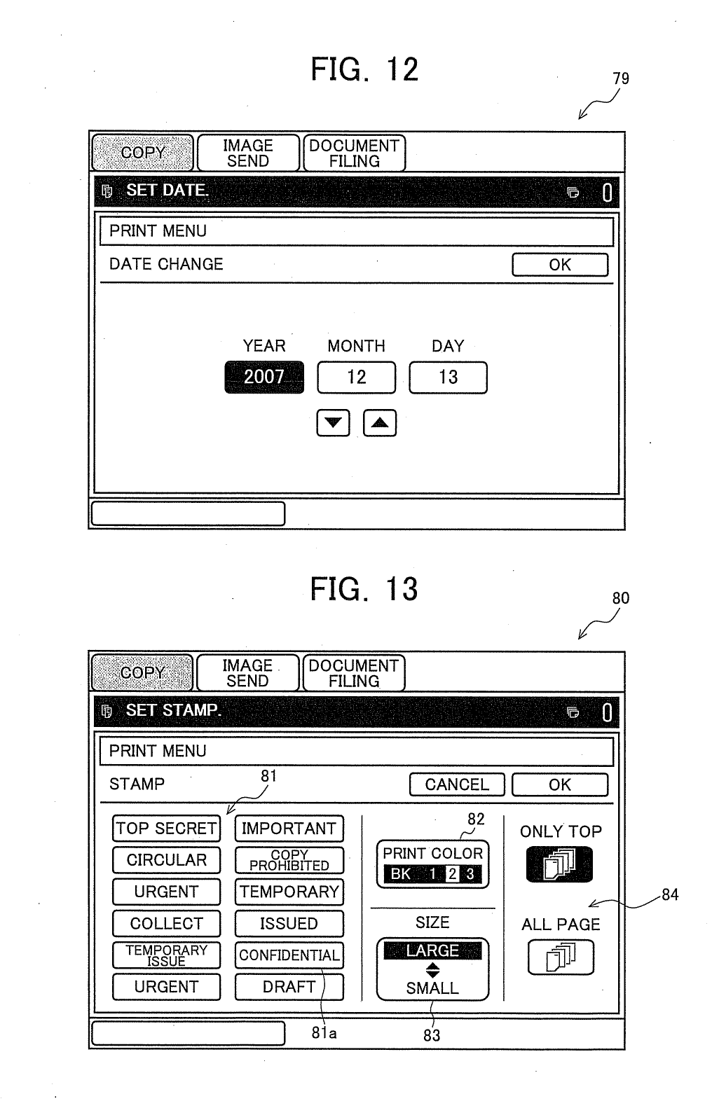

FIG. 10 is a diagram for showing an example of a GUI image displayed when a date key has been selected in the GUI image of FIG. 7 or 9. FIG. 11 is a diagram for showing an example of a GUI image displayed when a print color key has been selected in the GUI image of FIG. 10, and FIG. 12 is a diagram for showing an example of a GUI image displayed when a date change key has been selected in the GUI image of FIG. 10.

A GUI image 72 shown in FIG. 10 is displayed when the date key 52 has been selected from the GUI image 51 of FIG. 7 or the GUI image 70 of FIG. 9. In the GUI image 72, formats of date for displaying is displayed so as to be selectable from four types of formats 73, and separation marks of date 74 are also displayed so as to be selectable. In the GUI image 72, a print color key 75 for selecting a printing color, a date change key 76 for performing a change of date by inputting an arbitrary date, as well as a applying page selection key 77 for setting that date is applied to either on a top page or all pages, are further displayed so as to be selectable. By selecting the print color key 75 a screen is shifted to a GUI image 78 of FIG. 11, and it is possible to set the color. Furthermore, by selecting the date change key 76, a screen is shifted to a GUI image 79 of FIG. 12, and it is possible to set the date.

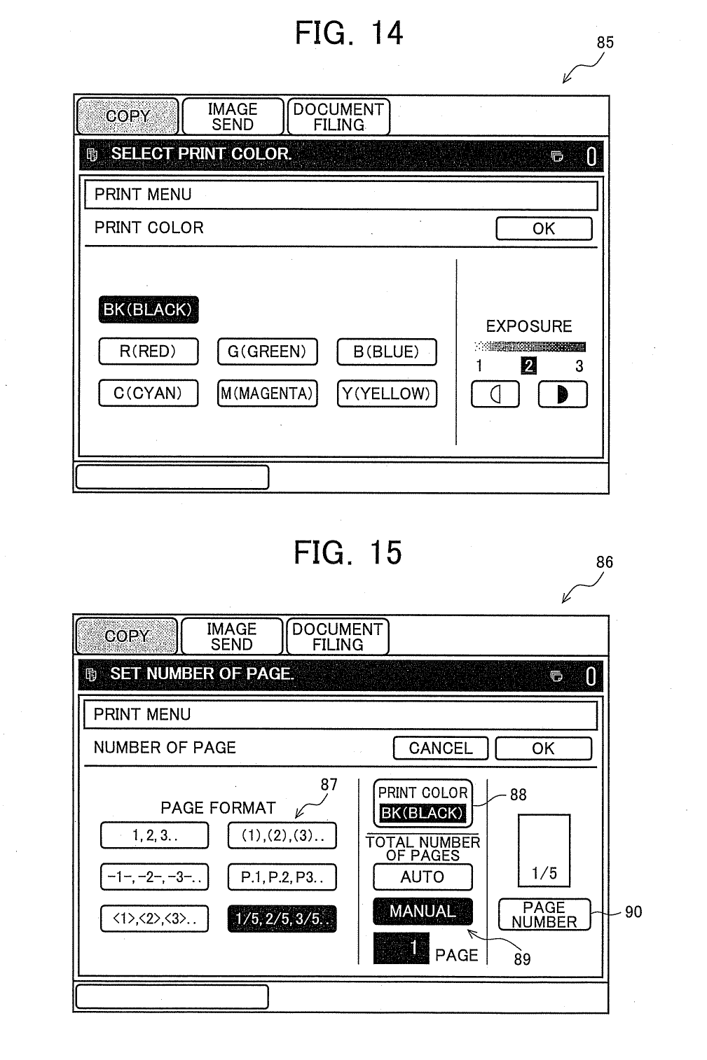

FIG. 13 is a diagram for showing an example of a GUI image displayed when the stamp key has been selected in the GUI image of FIG. 7 or 9, and FIG. 14 is a diagram for showing an example of a GUI image displayed when the print color key has been selected in the GUI image of FIG. 13.

A GUI image 80 shown in FIG. 13 is displayed when the stamp key 53 has been selected in the GUI image 51 of FIG. 7 or the GUI image 70 of FIG. 9. In the GUI image 80, as a fixed stamp, each of keys 81 corresponding respectively to “TOP SECRET”, “CIRCULAR”, “URGENT”, “COLLECT”, “TEMPORARILY ISSUE”, “URGENT”, “IMPORTANT”, “COPY PROHIBITED”, “TEMPORAL”, “ISSUED”, “CONFIDENTIAL” and “DRAFT” is displayed so as to be selectable. By selecting any of the keys 81, a fixed stamp text (fixed stamp image) to be added can be set. For example, by selecting the CONFIDENTIAL key 81a, a stamp text such as “CONFIDENTIAL” can be set. Furthermore, in the GUI image 80, a print color key 82 for selecting a printing color and print density, a size key 83 for selecting a print size, and an applying page selection key 84 for setting the fixed stamp is applied either to a top page or on all pages are displayed so as to be selectable. For example, by selecting the print color key 82, a screen is shifted to the GUI image 85 of FIG. 14, and it becomes possible to set colors and density.

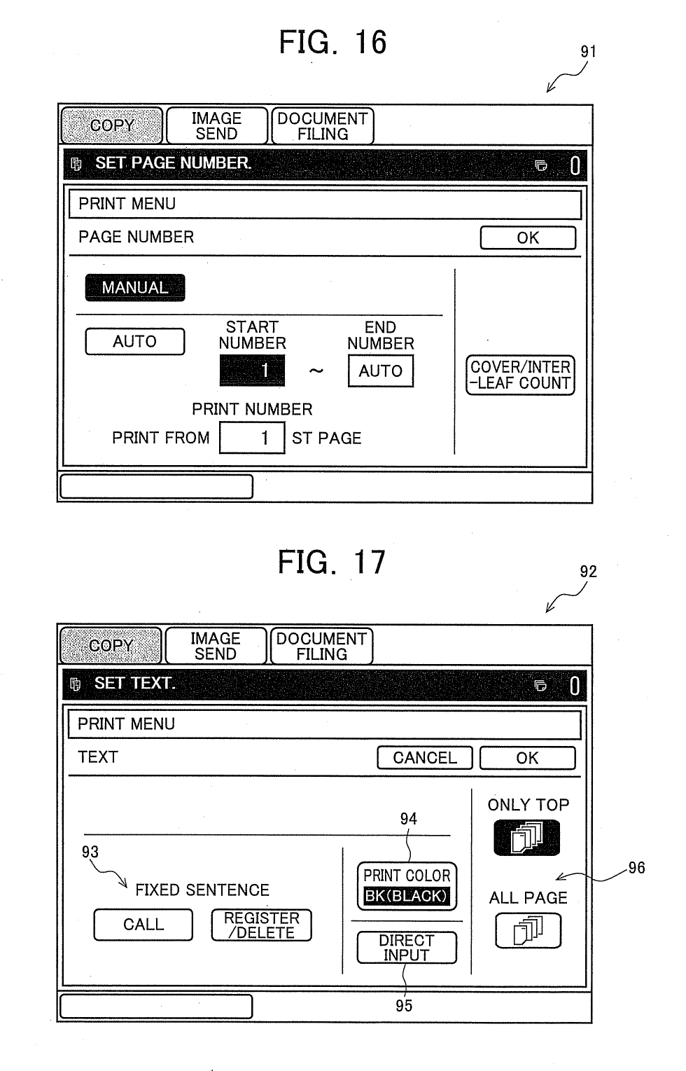

FIG. 15 is a diagram for showing an example of a GUI image displayed when the number of page key has been selected in the GUI image of FIG. 7 or 9, and FIG. 16 is a diagram for showing an example of a GUI image displayed when the page number key has been selected in the GUI image of FIG. 15.

A GUI image 86 shown in FIG. 15 is displayed when the number of page key 54 has been selected in the GUI image 51 of FIG. 7 or the GUI image 70 of FIG. 9. In the GUI image 86, formats of a page for printing is displayed so as to be selectable from six types of formats 87. In the GUI image 86, a print color key 88 for selecting a printing color of a page number, a total number of pages key 89 for setting the number of pages to which a page number is to be printed, as well as a page number key 90 for arbitrarily setting a page number to be printed are displayed so as to be selectable.

By selecting the print color key 88, a screen is shifted to the GUI image 78 of FIG. 11, and it becomes possible to set the printing color of the page number. In the total number of pages key 89, when selecting an automatic key, a page number identical to the number of sheets of read originals is added, and when selecting manual key, the total number of pages from 1 to 999 is manually input from a numeric keypad. By selecting the page number key 90 a screen is shifted to a GUI image 91 of FIG. 16, and it becomes possible to arbitrarily set the page number to be applied. In the GUI image 91 when selecting the automatic key, the page number is automatically applied, and when selecting the manual key, a start number of the page number, and a print start page can be set. In the GUI image 91, when applying a page number, a cover/interleaf count key for setting whether or not the page number is to be applied to a cover or an interleaf is also displayed so as to be selectable. By selecting the top page/interleaf count key, a screen is shifted to a not-shown GUI image whether the page number is to be printed on each of “cover”, “interleaf”, or “back cover” can be set. Thereby, a setting can be performed whether to print a page number on any one of or a plurality of “cover”, “interleaf” and “back cover” or not to print on any of them.

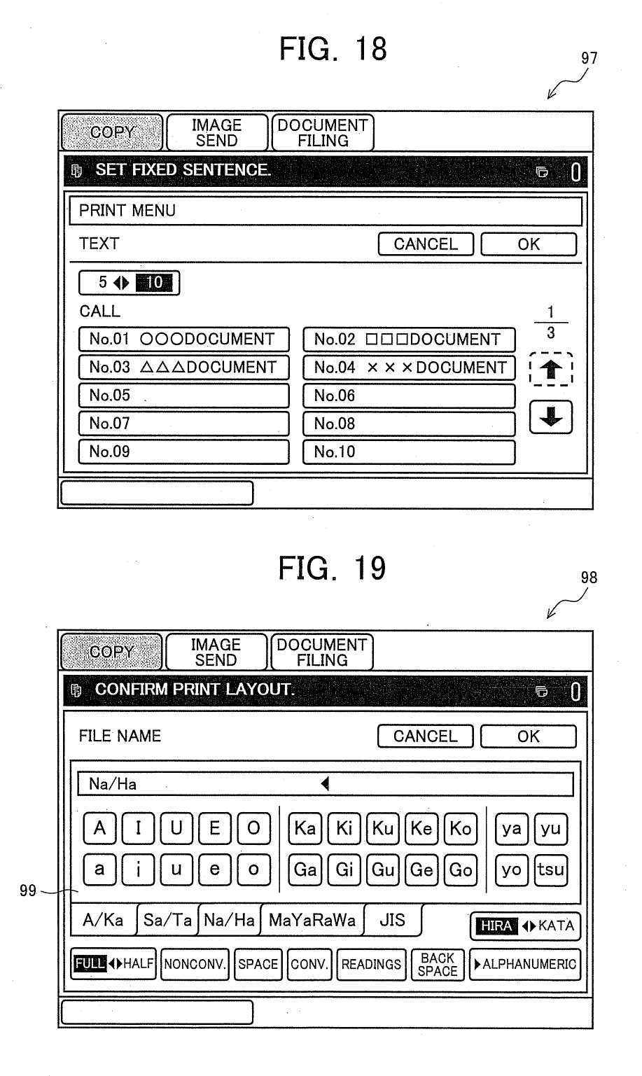

FIG. 17 is a diagram for showing an example of a GUI image displayed when the text key has been selected in the GUI image of FIG. 7 or 9. FIG. 18 is a diagram for showing an example of a GUI image displayed when a call key of a fixed sentence key has been selected in the GUI image of FIG. 17, and FIG. 19 is a diagram for showing an example of a GUI image displayed when a direct input key has been selected in the GUI image of FIG. 17.

The GUI image 92 shown in FIG. 17 is displayed when selecting the text key 55 in the GUI image 51 of FIG. 7, or the GUI image 70 of FIG. 9. In the GUI image 92, the fixed sentence key 93 including a call key and a register/delete key is displayed so as to be selectable. A fixed sentence registered by a user in advance is read out by the call key of the fixed sentence key 93, and a list display like in a GUI image 97 of FIG. 18 can be performed. Further, a fixed sentence registered by a user in advance is similarly read out by the register/delete key of the fixed sentence key 93 to be displayed by a list in the GUI image, so that an object can be selected to execute edition or deletion. Additionally, after a list display is similarly performed by the register/delete key, a new fixed sentence can be directly input to be registered in displaying the GUI image 98 of FIG. 19.

In the GUI image 92, a print color key 94 for selecting a color for printing text, a direct input key 95 for directly inputting text, as well as a applying page selection key 96 for setting the text is applied either to a top page or to all pages are displayed so as to be selectable. By selecting the print color key 94, a screen is shifted to the GUI image 78 of FIG. 11, and it becomes possible to set colors. By selecting the direct input key 95, a screen is shifted to the GUI image 98 of FIG. 19, and it is possible to arbitrarily input text desired by a user such as Japanese or English from a displayed keyboard image 99.

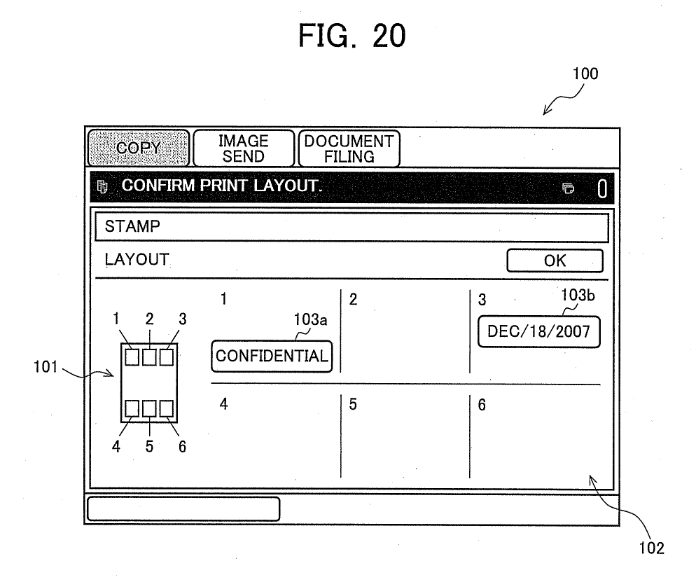

FIG. 20 is a diagram for showing an example of a GUI image displayed when the print layout key has been selected in the GUI image of FIG. 9. A GUI image 100 shown in FIG. 20 is displayed in a case where the print layout key 57a has been selected in the GUI image 70 of FIG. 9. Note that, the print layout key 57a is, as described above, displayed in a gray-out manner in an initial screen like the GUI image 51 of FIG. 7 so as not to be selectable, and is caused to be selectable by setting any of additional information among “date”, “stamp”, “number of page” and “text” to any position (upper left, upper middle, upper right, lower left, lower middle, or lower right) on recording paper. Here, description is being given supposing that the layout is changeable under the condition that at least one of the contents of the additional information is set, however when not the contents of the additional information is set, the print layout key 57 of FIG. 7 is also displayed so as to be selectable and by selecting the key, a screen is shifted to the similar GUI image 100, and an adding position of additional information may be set at first.

In the GUI image 100 shown in FIG. 20, an image (recording paper image) 101 corresponding to recording paper is displayed for showing each of adding positions (upper left, upper middle, upper right, lower left, lower middle and lower right), and a position-based additional information display area 102 for displaying the additional information added to each adding position so as to be easily understandable is displayed. Additionally, in the position-based additional information display area 102, contents of the additional information set to each position is displayed. In an example of the GUI image 100, a state is shown where a fixed stamp 103a of “CONFIDENTIAL” is set to be printed in the upper left side area, and further a date stamp 103b is set to be printed in the upper right side area.

In this state, when the fixed stamp 103a on the upper left side or the date stamp 103b on the upper right side is selected, a screen is shifted to a not-shown GUI image, and it is possible to delete and shift the selected stamp. As to the position shifting, in each additional position including upper left, upper middle, upper right, lower left, lower middle, or lower right, a setting of adding at the lowermost part as shown by the fixed stamp 103a, a setting of adding at the middle part as shown by the date stamp 103b, a setting of adding at the uppermost part, and the like are also selectable. Further, in a case where the stamp 103a or the stamp 103b is selected, it is possible to return a screen, for example, to the GUI image 70 of FIG. 9 or the GUI image 92 of FIG. 17. Thereby, in selecting the stamp 103a or 103b, a user operation to edit or delete the contents of each additional information, or a user operation to add new additional information can be received. Then the additional information can be changed based on the received user operation.

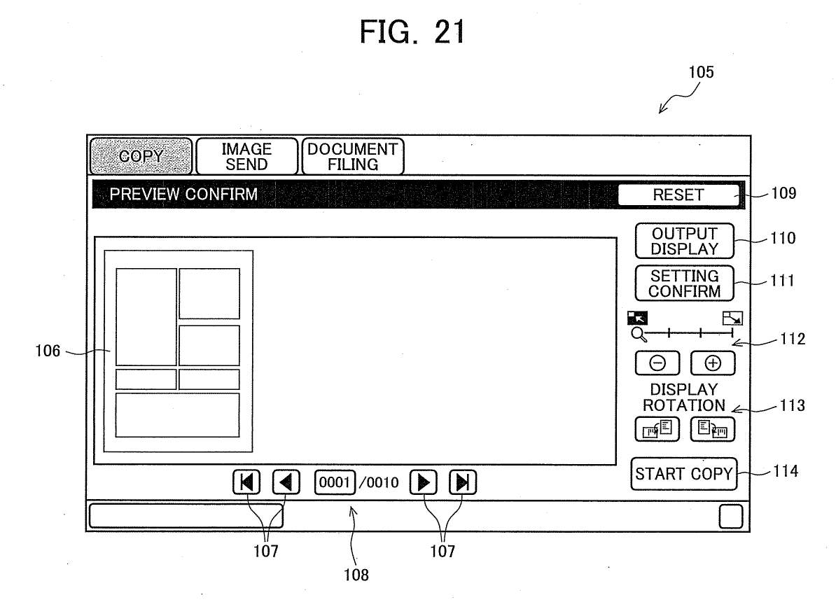

Description will be given for an example of a preview display after setting the contents of post processing and the position thereof as well as the contents of additional information and the adding position thereof by user interface images shown in FIGS. 4 to 20, with reference to FIGS. 21 to 25.

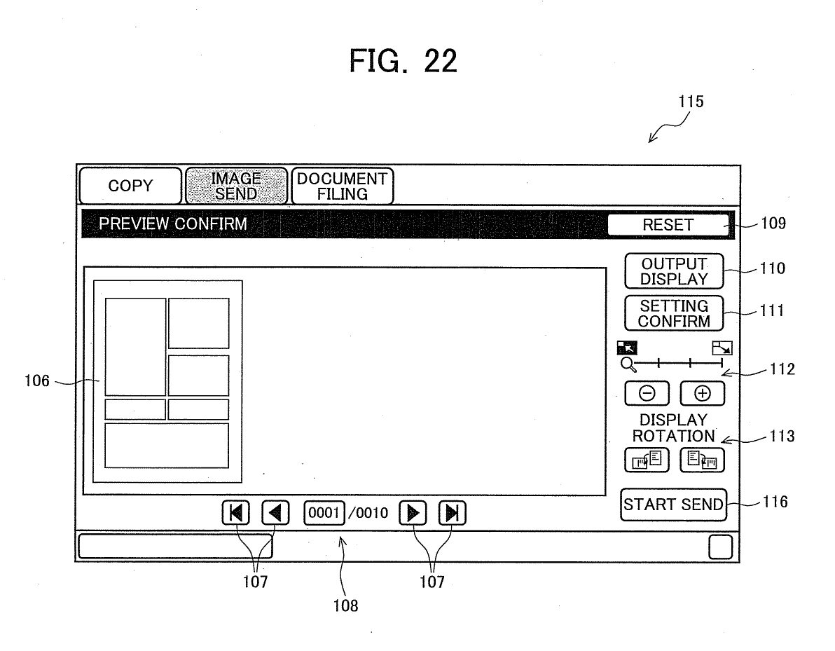

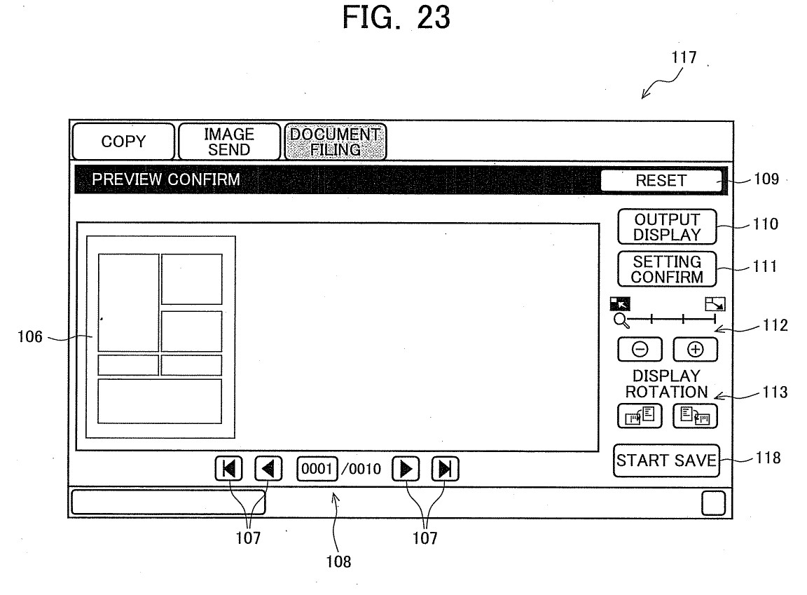

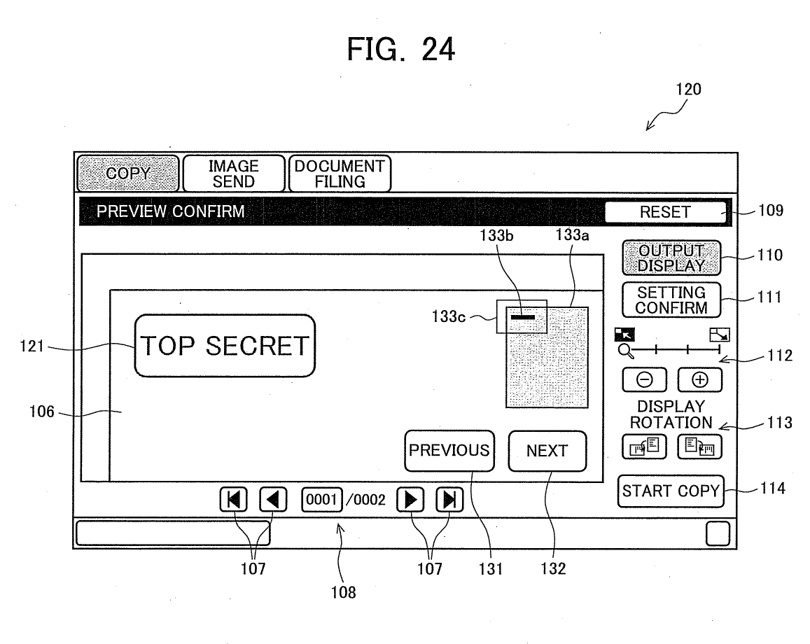

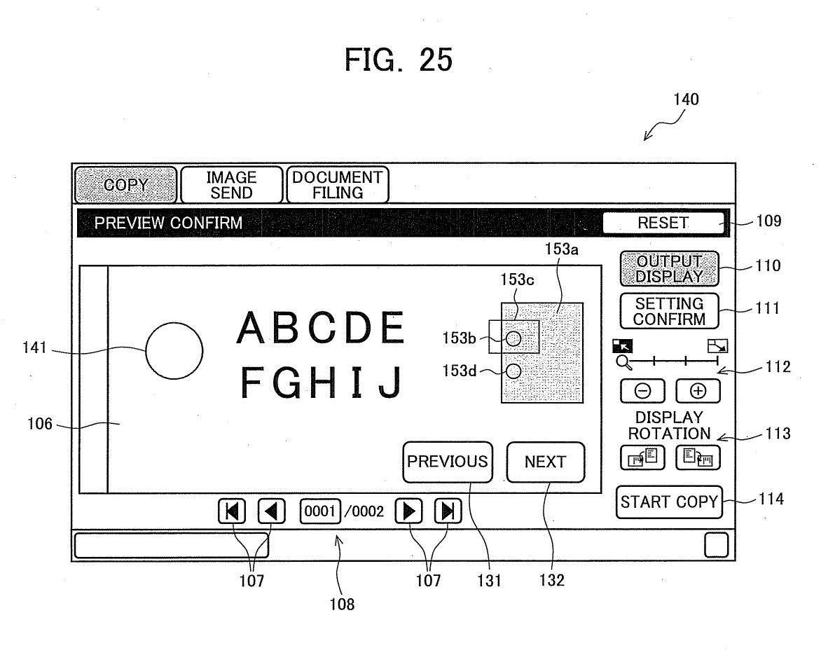

FIGS. 21 to 23 are diagrams for showing an example of a preview display screen in the digital multi-functional peripheral described in FIGS. 2 and 3, and FIG. 21 is an example of a preview display in a copy mode, FIG. 22 is an example of a preview display in an image send mode, and FIG. 23 is an example of a preview display in a document filing mode. Further, FIG. 24 is a diagram for showing an example of a GUI image when an output display key has been selected in the preview display screen of FIG. 21, and FIG. 25 is a diagram for showing another example of a GUI image when the output display key has been selected in the preview display screen of FIG. 21.

A GUI image 105 shown in FIG. 21 is displayed when the preview confirm key 45 in the GUI image 40 of FIG. 4 is selected (without shifting to another screen). In the GUI image 105, a preview image 106 generated, as described above, from an image data to be printed by the preview image generating portion 16a, is displayed on the touch panel 32 by the panel control portion 11.

The preview image 106 shows reduced image data per each page. Thus, together with information 108 showing a current page, a page switch key 107 for changing a page of image data displayed for previewing is displayed on the GUI image 105. The shift key 107 includes a top page shift key for displaying a first page, a previous page shift key for displaying a page before a current page, a next page shift key for displaying a page next to a current page, and a last page shift key for displaying a last page. The preview image 106 is displayed for each page in this manner and the user is able to display a preview image of an arbitrary page by operating the page switch key 107 as appropriate.

In the GUI image 105, a setting confirm key 111, an enlarging/reducing key 112, a display rotation key 113, and the like are further displayed so as to be selectable, and by operating these keys as appropriate, the user is able to confirm a setting of the preview image 106 or to confirm by enlarging/reducing or rotating the preview image 106. Moreover, in the GUI image 105, a reset key 109 is displayed so as to be selectable. When a necessity of resetting print conditions after confirming the preview image 106 arises, the user is able to display a GUI image for resetting the print conditions (including setting of post processing and adding processing of additional information) by operating the reset key 109. Then, it is possible to reset the print conditions using the resetting screen to display the preview image 106 based on the reset print conditions. In addition, a copy start key 114 is displayed in the GUI image 105 so as to be selectable, and when the user operates the copy start key 114, processing for performing image formation (printing) of the image data displayed for previewing is started. Note that, in facsimile reception, the preview image 106 in the GUI image 105 may be also displayed in the same manner.

In the GUI image 105, the output display key 110 for displaying an output state is also displayed. Description for a GUI image after selecting the output display key 110 will follow with reference to FIGS. 24 and 25.

Although description has been given for the preview display in the copy mode with reference to FIG. 21, a preview display in the image send mode or in the document filing mode is as illustrated in a GUI image 115 of FIG. 22 or a GUI image 117 of FIG. 23 respectively. Note that, even when additional information is not set, naturally, the GUI images 105, 115 and 117 of FIGS. 21 to 23 can be displayed.

The GUI image 115 is displayed when a preview confirm key (similar to the preview confirm key 45) displayed in selecting the image send mode selection key 42 is selected in the GUI image 40 of FIG. 4. In the GUI image 115, a preview image 106 generated, as described above, from image data to be sent by a facsimile sending or the like, by the preview image generating portion 16a is displayed on the touch panel 32 by the panel control portion 11. A send start key 116 instead of a copy start key 114 is displayed so as to be selectable in the GUI image 115, and when the user operates the send start key 116, processing for sending the image data displayed for previewing for a predetermined sending destination is started.

The GUI image 117 is displayed when a preview confirm key (similar to the preview confirm key 45) displayed in selecting the document filing mode selection key 43 is selected in the GUI image 40 of FIG. 4. In the GUI image 105, a preview image 106 generated, as described above, from image data to be filed obtained by reading by the reading portion 13, by the preview image generating portion 16a is displayed on the touch panel 32 by the panel control portion 11. A save start key 118 instead of the copy start key 114 is displayed so as to be selectable in the GUI image 117, and when the user operates the save start key 118, processing for filing image data displayed for previewing in the image storage portion 15 is started.

Description will be given for the display of the output state related to the printing in a copy mode (or in facsimile reception). Although it is also basically similar in image sending and in filing, the difference is the point that post processing by a post processing apparatus is not included. A user is able to confirm the output state after printing as a preview by operating the output display key 110 in a state where the preview image 106 of image data is displayed by the GUI image 105 of FIG. 21. The display of the output state is for displaying the characteristic part (a part of the additional information image showing the additional information and the post processing) so as to be recognizable, specifically so that the final state of the image formation can be confirmed, the characteristic part is automatically extracted and enlarged to be displayed (a display position is the position that is visually identified easily).

Since the fixed stamp image including “IMPORTANT” or “CIRCULAR” and the stamp images such as a page number set by a user, and the part where “punch” or “staple” is applied, are displayed so as to be easily recognizable, the user is able to easily confirm the set additional information or the contents of the post processing without unnecessary operation of enlarging, reducing or shifting. In addition, without confirming the entire image, by confirming only the necessary additional information or the contents of the post processing, the user is also able to give an instruction to execute printing. Furthermore, after displaying the characteristic part at the position that is visually identified easily, other parts are confirmed in accordance with the user's demand or the image is displayed in reduction so that the entire image can be confirmed. Note that, the color of the additional information image corresponding to “punch” or “staple” may be settable by a user.

Further, as described above, in a preview image with an additional information image added thereto, a combined part of the additional information image is displayed in enlargement, and the example of displaying in enlargement will be described. First, the preview image is an image in which an image data of the object to output is displayed sequentially in the unit of a page to be output. A display control portion then displays the preview image on which the additional information image is combined in enlargement, for a display size with which the entire page of the preview image is viewable. By performing such a display in enlargement, it is possible to confirm a final state in detail with the additional information image (the image such as a stamp and punch) after enlargement, displayed as the above-described combined part.

Specifically, by selecting the output display key 110, as shown in a GUI image 120 of FIG. 24 or in a GUI image 140 of FIG. 25, an additional information image 121 showing the additional information (a stamp and the like) that is added to a preview image 106 or an additional information image 141 showing post processing (punching and the like) is combined and the additional information images 121 and 141 are displayed after enlargement. Generation and composition of the additional information images 121 and 141 may be executed by the preview image generating portion 16a and the like as described above.

In this way, in accordance with the additional information being added or a content of post processing being applied, even in a case where a position of a characteristic part of the preview image is changed, a user is able to confirm the final state whether the additional information or post processing does not superimpose on an original image when being actually output, not by finding out the characteristic part to give an instruction by a user operation, but by looking at the characteristic part. Note that, the GUI image 120 of FIG. 24 or the GUI image 140 of FIG. 25 may be displayed instead of the GUI image 105 of FIG. 21 only with a selecting operation of a preview confirm key 45.

Furthermore, when the characteristic part is displayed after enlargement, the case where it is difficult for a user to grasp a position of the characteristic part to the entire sheet may also be assumed. Accordingly, as shown in FIG. 24 (FIG. 25), a reduced view 133a (153a) of the entire page of the preview image, a frame 133c (153c) showing which part of the reduced view (entire sheet) is currently displayed, and a position 133b (153b) of the additional information image may be displayed. The position 133b (153b) is preferably displayed with a rough-shaped figure of the additional information image.

In this way, the display control portion preferably displays the information showing a position relationship between the entire page of the preview image and the additional information image on the image display portion as well as the preview image where the additional information image is superimposed. Note that, in the GUI image 140 of FIG. 25, the position 153d showing another punch hole in the reduced view 153a is also displayed, and the position of other additional information image may be displayed as much as possible.

By displaying such that the position of the additional information image in the entire sheet can be found out, it is possible to instinctively recognize which part is being confirmed. That is, in performing a preview display, by displaying the characteristic part added to the preview image to be recognizable and displaying the characteristic part such that it is recognizable to which part of the entire page belongs, even in a case where the characteristic part is displayed after enlargement to be recognizable, which part of the entire page is being displayed is easily found out and the entire output state can also be recognized.

Next, a case where a plurality pieces of additional information are added to be output, and a case where the plurality pieces of additional information such as punch is combined will be described. In any of the cases, the plurality pieces of additional information are included, however, it is difficult to display these pieces information after enlargement at the same time to be visually identified easily in a small screen like a touch panel 32. Accordingly, it is preferable, by determining a priority order in advance in preparation for the case where the plurality of additional information images are displayed for previewing, to be configured to display sequentially the additional information image (that is, the combined part of the additional information image) to be able to confirm the final state.

Accordingly, the display control portion, in a case where a plurality pieces of additional information to be combined with the preview image exist, preferably determines the combined part of the additional information image to be displayed after enlargement (that is, additional information image to be displayed at a position to be visually identified easily) in accordance with the predetermined priority order. Based on the determination, the display control portion, of course, executes the display. In this way, by controlling the display of the additional information image based on the priority order, it is possible to display preferentially and confirm the important characteristic part as the final state of image formation.

For example, it is possible to display preferentially punch holes considering that attention is needed since there is a possibility that the image of punch is completely missed. On the other hand, it is possible to be configured such that the important characteristic part can be confirmed first by raising the priority order of stamp images (especially the fixed stamp image” such as “TOP SECRET”, “IMPORTANT”, and “URGENT”. That is, in a case where a stamp image is added as additional information, the predetermined priority order may be an order in which additional information image showing the stamp image is given preference over other additional information image. There are a number of fixed stamp images that are important as information, and whether these important information are surely added may be displayed preferentially to be confirmed. In addition, among the stamp images, the priority order of “CIRCULAR”, for example, may be lowered.

In addition, the priority order of the additional information image may be raised as positioned on the upper side rather than the lower side to the preview image. That is, the predetermined priority order may be an order in which the additional information image that is combined in the upper part is given preference over the additional information image that is combined in the lower part. By raising the priority order of the additional information image positioned on the upper side, the additional information image can be confirmed sequentially from the upper side to the lower side of a page so that the position relationship is found out easily and can confirmed more easily.

In addition, in order to sequentially display the plurality of additional information images, it is preferable to display icons (previous key 131 and next key 132) shown in FIGS. 24 and 25 and to switch the display in accordance with a user operation of these icons. Thereby, the user sequentially switches the display after confirming the final state of the additional information image individually so that it is possible to reliably confirm the additional information image one by one to be able to exclude the failure in confirmation. For example, in the GUI image 140 of FIG. 25, the additional information image 141 showing one punch hole is displayed first, and when the next key 132 is selected, the entire preview image 106 may be shifted and displayed such that the other punch hole (the part shown by the position 153d) is displayed.

In this way, the digital multifunctional-peripheral 1 is preferably provided with a switch operation portion that receives a user operation to switch the additional information image (that is, the combined part to be displayed after enlargement) to be displayed at a position that is visually identified easily in the image display portion, among the plurality of additional information images. The ones illustrated in the touch panel 32 and the key operation portion 31 are applicable for the switch operation portion. The display control portion may execute switching in accordance with the predetermined priority order based on the user operation received by the switch operation portion.

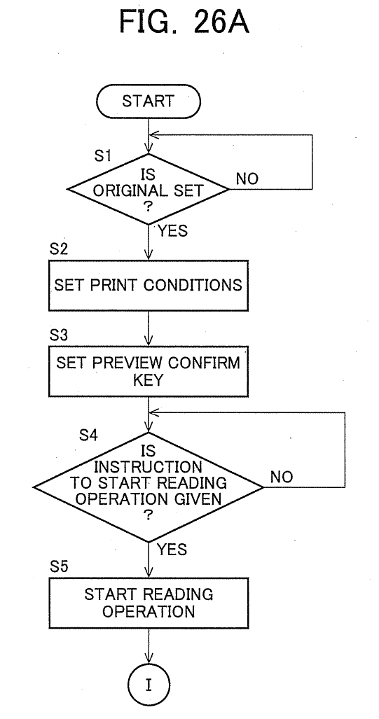

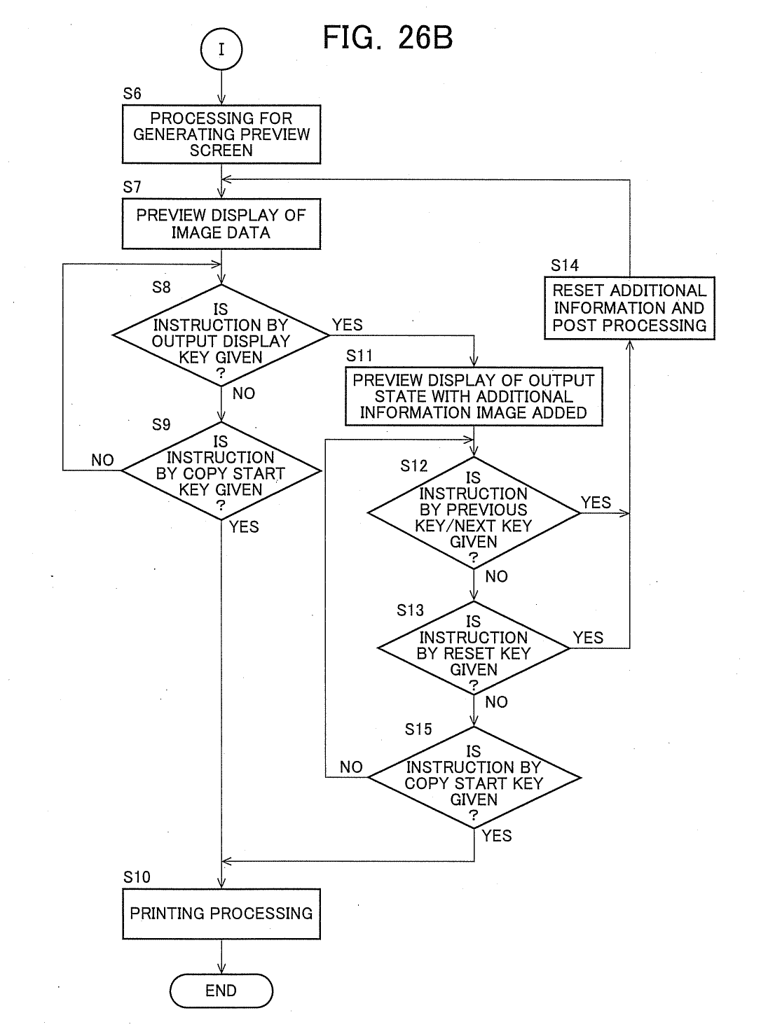

Next, description will be given for the flow when an original image to be printed (the object of image formation) is read to be displayed for previewing with reference to FIGS. 26A and 26B. FIGS. 26A and 26B are flowcharts for explaining an example of processing when performing a preview display in printing in the digital multi-functional peripheral of FIGS. 2 and 3.

First, the main control portion 18 confirms whether an original is set on a document table or a document feeder in the reading portion 13 (step S1), and when the original is set (in the case of YES at step S1), a user operation for setting print conditions is received to reflect the setting (step S2). Then, the main control portion 18 performs a setting of the preview confirm key (step S3). When the preview confirm key 45 of FIG. 4 is operated by a user before a copy is started, it is set such that a preview image is displayed after reading image data.

Then, the main control portion 18 waits for an instruction to start a reading operation (step S4), and when the instruction is received, the reading portion 13 is instructed to perform original reading (step S5). Whereby, the reading portion 13 starts the original reading. Subsequently, the main control portion 18 instructs the preview image generating portion 16a to execute the processing of generating a preview image based on the read image data (step S6) and instructs the panel control portion 11 to display the preview image on the touch panel 32 (step S7). With this processing, for example, the GUI image 105 of FIG. 21 is displayed.

In the display state of the preview image 106 by the GUI image 105, the main control portion 18 determines whether or not an instruction by the output display key 110 is given (step S8). When the instruction by selecting the output display key 110 is not given, whether or not an instruction to start a copy by the copy start key 114 is given is then determined (step S9), and when the instruction to start a copy is given, printing processing of the image data is started (step S10). Alternatively, when the instruction to start a copy is not given at step S9, the procedure returns to step S8.

When the instruction by the output display key 58 is given at step S8, the main control portion 18 instructs the preview image generating portion 16a to generate an additional information image. Then, the panel control portion 11, displays the generated additional information image in a state of being added to the preview image 106 (output state) like in the GUI image 120 of FIG. 24 and the GUI image 140 of FIG. 25 on the touch panel 32 (step S11). At the same time, the icons (previous key 131 and next key 132) are displayed and each of information 133a to 133c (153a to 153d) is also displayed.

Then, the main control portion 18 determines whether or not a selection instruction by the previous key 131 or the next key 132 is given (step S12), and when the selection instruction is given, based on the instruction, performs a preview display such that the previous or the next additional information image (the previous or the next combined part) is displayed after enlargement (in other words, is shifted to the position that is visually identified easily and displayed) (step S11).

In the case of NO at step S12, whether or not the selection instruction by the reset key 109 is given is determined (step S13), and when the selection instruction is given, confirmation and resetting of contents and a position of additional information and post processing are performed (step S14), and the procedure returns to step S7 to perform a preview display and wait for an instruction to display an output again. Alternatively, the procedure may return to step S11 after step S14. On the other hand, when the selection instruction is not given at step S13, the main control portion 18 determines whether or not an instruction to start a copy by the copy start key 114 is given (step S15), and when the instruction to start a copy is given, printing processing of the image data is started (step S10), and when the instruction to start a copy is not given, the procedure returns to step S12.

In the above, description has been given for the preview display accompanied by the additional information image of the present invention with reference to the digital multi-functional peripheral 1, however, the present invention may employ an embodiment as a preview display method in such an image forming apparatus. That is, when the image forming apparatus outputs by adding the additional information or applies post processing on recording paper on which image data is printed, the preview display method includes a step of combining additional information or an additional information image showing post processing with a preview image at a position that corresponds to an adding position of additional information or a position at which post processing is applied in displaying a preview image, and a step of displaying a preview image by enlarging a part where the additional information image is combined. Another example of application is as has been described.

Alternatively, such a preview display can be executed by a control program (printer driver) for digital multi-functional peripheral 1 that is incorporated into a PC (PC2, PC3, and the like of FIG. 1) connected to an image forming apparatus including the digital multi-functional peripheral 1. In other words, as an example of realization by a printer driver will be shown below, the present invention may employ an embodiment as a preview display method in a computer.

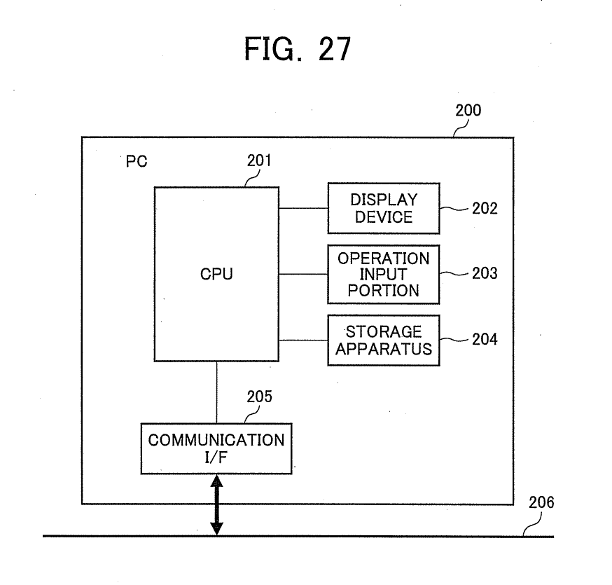

FIG. 27 is a diagram for showing an exemplary configuration of a general PC, which also shows an exemplary configuration of a PC into which a printer driver of the present invention can be incorporated. A PC 200 illustrated in FIG. 27 is provided with a display device 202 which is an example of a display portion, an operation input portion 203 composed of a keyboard, a pointing device, or the like, a storage apparatus 204 composed of a hard disc, a RAM, a ROM, or the like, a communication I/F 205 for connecting to an external device such as the digital multi-functional peripheral 1 via a network 206, and a CPU 201 for executing various calculation processing to perform control thereof.

An operation system that performs basic control is stored in the ROM or the hard disc so as to be executable by developing on the RAM by the CPU 201. In the hard disc, application software such as document creation software and figure creation software as well as the printer driver according to the present invention are stored similarly so as to be executable by developing on the RAM by the CPU 201. The printer driver sends a printing command related to image data generated by, for example, the document creation software or figure creation software to the digital multi-functional peripheral 1 while communicating with the digital multi-functional peripheral 1 connected by the network 206 or the like through the communication I/F 205. An operation of the application software, a print setting by the printer driver, a preview display, and the like are executed by a user operation from the operation input portion 203.

The printer driver according to the present invention is a program for causing the PC 200 to execute a step of generating a preview image from image data of the object to output by the digital multi-functional peripheral 1, a step of displaying a preview image on the display device 202 of the 200 and a step of, a step of combining the additional information and the additional information image showing post processing at the time of displaying a preview image, when the image data of the object to output by the digital multi-functional peripheral 1 is output with additional information added thereto or printed recording paper is output to which post processing is applied, and a step of displaying the preview image on the display device 202 by enlarging a part where additional information image is superimposed.

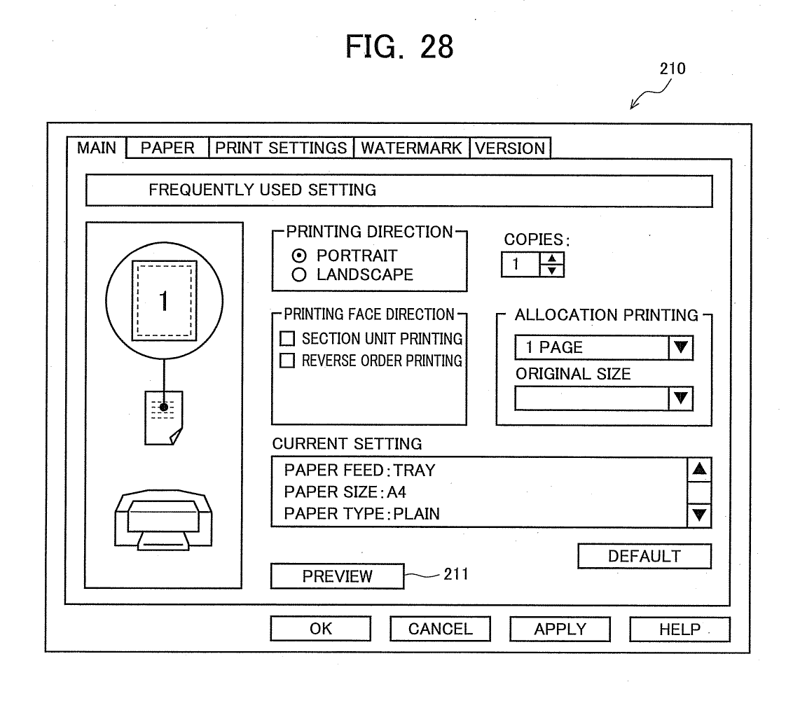

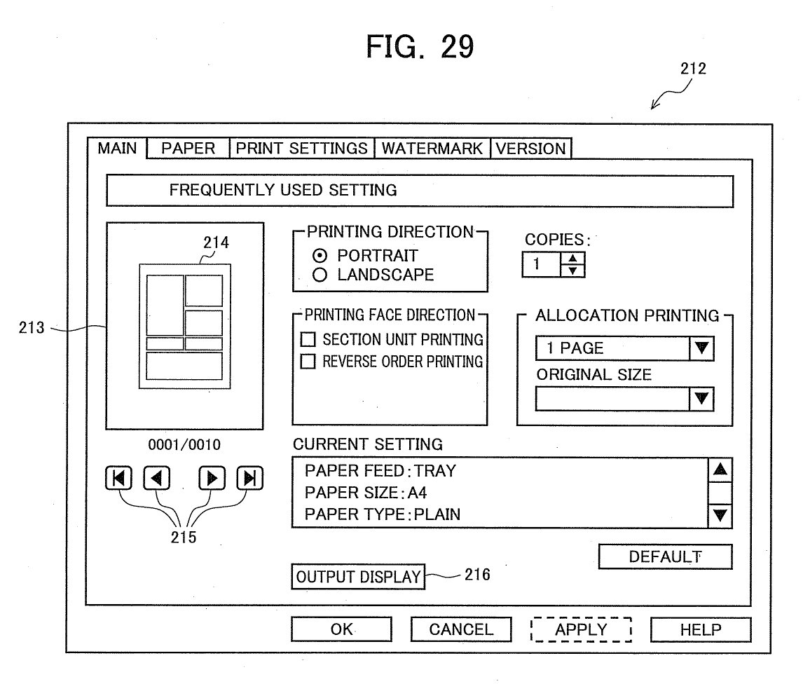

FIGS. 28 to 30 are diagrams for showing an example of a GUI image for setting a series of printing in the printer driver according to the present invention. In a GUI image 210 shown in FIG. 28, similarly to a general printer driver, a preview confirm key 211 is displayed so as to be selectable in addition to setting items such as a printing direction and the number of printing. The preview confirm key 211 is selected to shift to a GUI image 212 shown in FIG. 29. In the GUI image 212, a preview image 214 generated from image data to be printed is displayed in a preview display area 213 and a display switch key 215 for changing a display page of the preview image 214 is also displayed so as to be selectable.

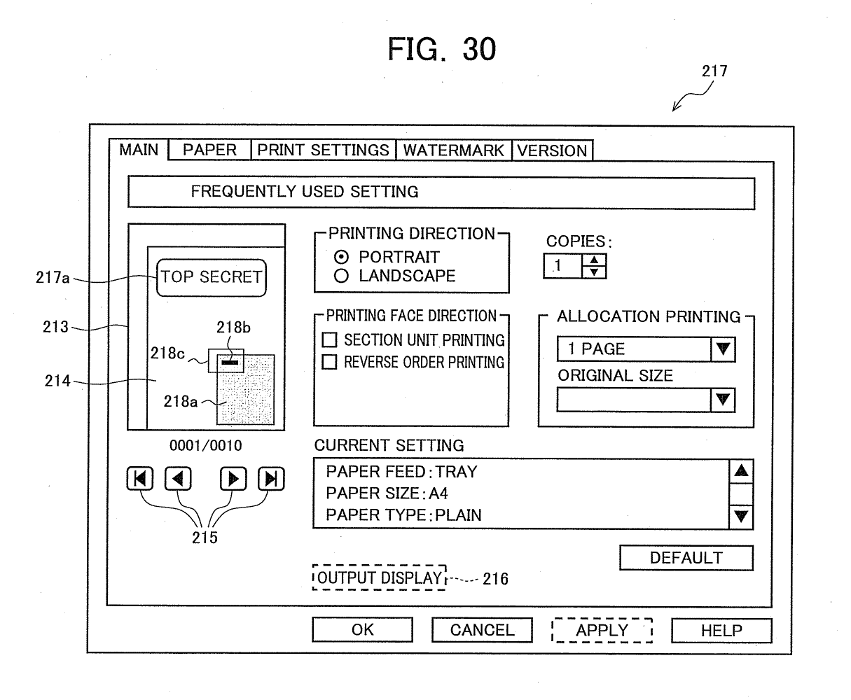

In the GUI image 212, an output display key 216 is further displayed so as to be selectable. The output display key 216 is selected to shift to a GUI image 217 shown in FIG. 30. In the GUI image 217, an additional information image 217a, by overlaying on the preview image 214, is displayed in enlargement in the preview display area 213 in the same manner as the description for the GUI image 120 of FIG. 24 and the GUI image 140 of FIG. 25, and information 218a to 218c (corresponding to 133a to 133c of FIG. 24, respectively) for showing a position at which the additional information 217a is added is displayed. At this time, an output display key 216a is not selected.

In this example, it is confirmable that stamp information “TOP SECRET” is added to the upper left of the image data. Naturally, it is possible to set contents and a position of additional information and post processing by the printer driver. Other example of application related to displaying an image in enlargement of a specified information image, for example, an example of responding to a plurality of specified information images (display of icons 131 and 132, and the like) and the like are all applicable similarly to a preview display in the digital multi-functional peripheral 1, the description thereof will be omitted. By selecting, for example, an OK key in the GUI image 217, a printing instruction with adding processing of additional information and post processing is sent to the side of the digital multi-functional peripheral 1 to execute printing.

A preview display method in a computer according to the present invention includes a step as has been described for a printer driver. That is, the preview display method includes a step in which a computer generates a preview image from image data of the object to output by the image forming apparatus connected to the computer in the image forming apparatus, a step of, when the computer outputs image data with additional information added thereto or applies post processing on recording paper on which image data of the object to output is printed, combining additional information or additional information image showing post processing with a preview image at a position corresponding to an adding position of additional information or a position at which post processing is applied in displaying a preview image, and a step in which a computer displays a preview image by enlarging a part where the additional information image is superimposed on a display portion that is provided with the computer. Note that, in the case of employing such a preview display method in a computer, a function of a similar preview display that has been described with reference to each diagram on the side of the image forming apparatus.

According to the present invention, in the case of outputting image data that is the object of the output with the additional information added thereto and in the case of outputting a recording medium where post processing such as punching or stapling is applied, it is possible to confirm the additional information that is added and the post processing that is applied without requiring user operations including enlarging, reducing, and shifting in displaying a preview.

1. An image forming apparatus which has an image display portion for displaying a preview image of image data of an object to output, wherein
a display control portion is included, when outputting the image data of the object to output with an additional information added thereto, or printing the image data of the object to output on recording paper and applying post processing to the recording paper, to superimpose an additional information image showing the additional information or the post processing on the preview image at a position corresponding to an adding position of the additional information or a position at which the post processing is applied in displaying the preview image and to enlarge and display a part where the additional information image is superimposed.

2. The image forming apparatus as defined in claim 1, wherein
the display control portion displays an information showing a position relationship between the entire page of the preview image and the additional information image together with the preview image on which the additional information image is superimposed on the image display portion.

3. The image forming apparatus as defined in claim 1, wherein
the display control portion displays a part on which the additional information image is superimposed one after another according to a predetermined priority order when there are a plurality of additional information images to be superimposed on the preview image.

4. The image forming apparatus as defined in claim 3, wherein
the predetermined priority order is an order that the additional information image superimposed on the upper part of the preview image is given preference over the additional information image superimposed on the lower part thereof.

5. The image forming apparatus as defined in claim 3, wherein
when adding a stamp image as the additional information, the predetermined priority order is an order that the additional information image showing the stamp image is given preference over the other additional information image.

6. The image forming apparatus as defined in any one of claims 3 to 5, wherein
a switch operation portion is further provided to receive a user operation for performing switching of a display of the additional information image, and the display control portion executes the switching according to the predetermined priority order based on the user operation received by the switch operation portion.

7. A preview display method in an image forming apparatus provided with an image display portion that displays a preview image of image data of an object to output, wherein
a step in which the image forming apparatus, when the image forming apparatus outputs the image data of the object to output with an additional information added thereto, or when the image forming apparatus performs post processing to recording paper after printing the image data of the object to output on the recording paper, superimposes an additional information image showing the additional information or the post processing on the preview image at a position corresponding to an adding position of the additional information or a position at which the post processing is applied in displaying the preview image; and
a step in which the image forming apparatus enlarges a part on which the additional information image is superimposed, and displays the preview image.

8. A preview display method, comprising:
a step in which a computer generates a preview image from an image data of an object to output by an image forming apparatus connected to the computer;
a step in which the computer, when it outputs the image data of the object to output with an additional information added thereto in the image forming apparatus, or it applies post processing to recording paper after printing the image data of the object to output on the recording paper, superimposes an additional information image showing the additional information or the post processing on the preview image at a position corresponding to an adding position of the additional information or a position at which the post processing is applied at the time of displaying the preview image; and
a step in which the computer enlarges a part on which the additional information image is superimposed and displays the preview image on a display portion included in the computer.
